(19) United States
(12) Patent Application Publication
(10) Pub. No.: US 2017/0226663 A1
(43) Pub. Date: Aug. 10, 2017

(54) METHOD OF MAKING SHEAR SPUN FIBERS AND FIBERS MADE THEREFROM

(71) Applicant: SABIC GLOBAL TECHNOLOGIES B.V., Bergen op Zoom (NL)

(72) Inventors: Jacob Scott Labelle, Pittsfield, MA (US); Richard Peters, Hinsdale, MA (US); Roy Martinus Adrianus L'abee, Veldhoven (NL); Jin Xuezhi, Branford, CT (US); William Hollar, Jr., Mt. Vernon, IN (US); Pete Geisen, Raleigh, NC (US); Narendiran Vitchuli, Raleigh, NC (US); Ransom Kochhar, Raleigh, NC (US); Ian Rogers, Raleigh, NC (US)

(21) Appl. No.: 15/519,249

(22) PCT Filed: Oct. 16, 2015
(86) PCT No.: PCT/IB15/57981

§ 371 Date: Apr. 14, 2017

Related U.S. Application Data
(60) Provisional application No. 62/208,078, filed on Aug. 21, 2015.
(60) Provisional application No. 62/065,195, filed on Oct. 17, 2014.

(51) Int. Cl. D01D 5/40; C08L 79/08; D01D 5/06

(52) U.S. Cl. CPC D01D 5/40; D01D 5/06; C08L 79/08; C08G 73/106

(57) ABSTRACT

In an embodiment, a method of making fibers comprises: flowing a dispersion medium through a reaction tube, wherein the dispersion medium comprises an anti-solvent; adjusting a temperature of a polymer solution to form a stable polymer solution, wherein the polymer solution comprises a polymer and a solvent; introducing the stable polymer solution into the dispersion medium to form a polymer dispersion comprising the dispersion medium and a plurality of polymer components of the polymer solution; and shearing the dispersed-phase components by flowing the dispersion system through the reaction tube, wherein a plurality of fibers having an average diameter of less than or equal to 10 μm are formed.

### CROSS-REFERENCE TO RELATED APPLICATIONS

The present application is an international application claiming priority to Provisional Application No. 62/065,195 Filed Oct. 17, 2015, and Provisional Application No. 62/208,078 Filed Aug. 21, 2015, both of which are incorporated herein in their entirety by reference.

### BACKGROUND

This application is directed to methods of making shear spun fibers and the fibers made therefrom.

Small fibers can be produced in various fashions including drawing, template synthesis self-assembly, phase separation, and electrospinning. Possible commercial production has focused on, melt blowing, and splitting/dissolving of bicomponent fibers. These processes, however, are limited to melt-processable polymers. Electrospinning, which can produce the smallest fibers (20-2000 nm in diameter), has a low production rate. For the wide commercialization of fibers having an average diameter of less than 10 micrometers (μm), a method of fiber production that is capable of several orders of magnitude higher productivity is needed.

Polyetherimide (PEI) fibers, polyphenylene ether (PPE) resin, polybutylene terephthalate (PBT) resin fibers, and polycarbonate (PC) and PC copolymer fibers, are used in many applications and composite structures that require various unique properties of the different resins to perform in the necessary environment. Many of these applications require the resins to be in a fiber size much smaller than currently achievable using conventional methods of fiber production at a reasonable throughput rate. This has been a barrier to the introduction and testing of many of these resins suitability for use in these applications. PEI, PC and PC copolymers have been converted into fibers using the melt spinning to a size in the range of 10-20 micrometers (μm). PBT and PPE-based resins have been converted down to 15 to 20 micrometers in diameter using the melt spinning process.

For the foregoing reasons, there is a continuing need for improved techniques for fabricating fibers from polymers that are unstable in solution at room temperature.

### BRIEF DESCRIPTION

Disclosed herein are methods of making fibers and fibers made therefrom.

In an embodiment, a method of making fibers comprises: flowing a dispersion medium through a reaction tube, wherein the dispersion medium comprises an anti-solvent; adjusting a temperature of a polymer solution to form a stable polymer solution, wherein the polymer solution comprises a polymer and a solvent; introducing the stable polymer solution into the dispersion medium to form a polymer dispersion comprising the dispersion medium and a plurality of polymer components of the polymer solution; and shearing the dispersed-phase components by flowing the dispersion system through the reaction tube, wherein a plurality of fibers having an average diameter of less than or equal to 10 μm are formed.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a cross-sectional view of an example of a shear flow system that may be utilized for fabricating fibers.

FIG. 2 is a cross-sectional schematic view of an example of a continuous shear flow apparatus.

FIG. 3 is a cross-sectional schematic view of another example of a continuous shear flow apparatus.

FIG. 4 is a cross-sectional schematic view of another example of a continuous shear flow apparatus.

FIG. 5 is an SEM micrograph of fibers produced by a continuous process utilizing an apparatus such as illustrated in FIG. 2, and in accordance with Example 1.

FIG. 6 is an SEM micrograph of nanofibers produced by a continuous process utilizing an apparatus such as illustrated in FIG. 2, and in accordance with Example 2.

FIG. 7 is an SEM micrograph of the resulting product of a continuous process utilizing an apparatus such as illustrated in FIG. 2, and in accordance with Example 5.

FIG. 8 is an SEM micrograph of a fiber bundle.

FIG. 9 is a cross-sectional schematic view of another example of a continuous shear flow apparatus comprising a countercurrent injection at a point near the center of the reaction tube.

FIG. 10 is an SEM micrograph of the resulting product of a continuous process utilizing an apparatus such as illustrated in FIG. 2, and in accordance with Example 6.

FIG. 11 is an SEM micrograph of the resulting product of a continuous process utilizing an apparatus such as illustrated in FIG. 2, and in accordance with Example 7.

FIG. 12 is an SEM micrograph of the resulting product of a continuous process utilizing an apparatus such as illustrated in FIG. 2, and in accordance with Example 8.

FIG. 13 is an SEM micrograph of the resulting product of a continuous process utilizing an apparatus such as illustrated in FIG. 2, and in accordance with Example 9.

### DETAILED DESCRIPTION

It has been discovered that the shear spun technique described in US Publication 2013/0012598 to Velev et al. (hereinafter referred to as the “original shear spun technique”) successfully forms fibers in a commercially scalable process for many polymers. However, the process has been less effective with some polymers, forming fibers that are too large, and/or forming a low number of fibers. For example, the original shear spun technique successfully produced fibers for the base polyetherimide (“PEI”) (such as ULTEM™ 1000 and ULTEM™ 1010 commercially available from SABIC), which is PEI based on 4,4′-bisphenol A dianhydride (“BPADA”) and metaphenylene diamine (“mPD”), and which has an average molecular weight (Mw) of 30,000 to 60,000 Daltons. The fibers produced had average diameters in the 600-700 nanometer (nm) range. The original shear spun technique, however, didn't work for chemically resistant PEI (e.g., ULTEM™ CRS commercially available from SABIC) which is based on BPADA and paraphenylene diamine (“pPD”), and which has a Mw of 40,000 to 100,000 Daltons. Unless specifically specified otherwise herein, the molecular weight is determined using gel permeation chromatography using polystyrene standard. Essentially, with the chemically resistant PEI few fibers were formed and the fibers had the wrong size (e.g., the average diameter of the fibers obtained was 1-25 micrometers (μm)); essentially, sheets and ribbons formed.

For polymers which fail to remain at a stable state during the original shear spun technique, a new process has been developed where a polymer solution of the polymer (also referred to as the polymer component) dissolved in a solvent is formed. The temperature of the polymer solution is adjusted to a temperature where the solution is stable, i.e., wherein the polymer remains in solution (does not precipitate out of solution forming solid(s)).

During the formation of the fibers, the polymer solution and a dispersion medium (which comprises an anti-solvent, and optionally comprises a carrier and further optionally comprises a viscosity modifier) are combined under a shear stress, causing the polymer to precipitate out of solution and enabling the shear stress to form the precipitated polymer into fibers. Optionally, the dispersion medium can have a controlled temperature. Optionally, the temperature of the dispersion medium can be adjusted (increased or decreased from room temperature (e.g., from 25° C.) down to near the freezing point of the anti-solvent and up to the near boiling point of the anti-solvent).

Therefore, the present shear spun process comprises forming a polymer solution of a polymer dissolved in a solvent; adjusting a temperature of the polymer solution to a stability temperature where the polymer remains in solution (e.g., less than 1 gram polymer per liter of solvent (g/L) is not dissolved, specifically, less than or equal to 0.1 g/L); combining the polymer solution and a dispersion medium to form a combined mixture and to cause the polymer to precipitate, wherein the combined mixture is under shear forces; forming fibers; and collecting the plurality of polymeric fibers, e.g., at a rate of at least 300 grams/hour The polymer solution is maintained at the stability temperature until it is combined with the dispersion medium. Desirably, the polymer solution is maintained under an inert atmosphere throughout the process to avoid undesirable side reactions.

Using the shear spinning process, these materials can be solution spun into fiber diameters of less than or equal to 10 micrometers (μm), e.g., to diameters in the sub-micrometer range. Even small decreases in fiber diameters results in substantial increases in the surface area of the resins, thereby increasing the performance benefit that the individual resins bring to the applications.

The output of this process is bulk staple fiber. The fibers can be used as is, or can be cut to further shorten the fiber length. This fiber can then be used in downstream wet laid or dry laid non-woven processes, or sprayed as a coating onto another substrate, or rolled onto a product. These processes are used to produce applications such as membranes (e.g., battery separators), composites, paper (e.g., electrical papers, honeycomb papers, filtration media), and the like.

The polymer solution comprises a polymeric component. The polymeric component can optionally have a Mw of greater than or equal to 5,000 Daltons, greater than or equal to 25,000 Daltons, or greater than or equal to 50,000 Daltons, e.g., 50,000 to 150,000 Daltons, specifically, 70,000 to 100,000 Daltons, or 80,000 to 125,000 Daltons. As used herein the Mw is determined with gel permeation chromatography (GPC) using a polystyrene standard. Examples of polymeric components include a polyetherimide, polycarbonate, polyether ether ketone (PEEK), polyphenylene sulfones, a poly(phenylene ether), polyethylene naphthalate (PEN), Poly Amic Acid (PAA), and combinations comprising at least one of the foregoing, e.g., a poly(phenylene ether)-polysiloxane block copolymer, polycarbonate copolymer, polyetherimide homopolymers, PEN/PEI blends, (e.g., PEN/ULTEM blends, such as PEN/ULTEM™ CRS blends), ULTEM™ CRS/ULTEM™ blends (e.g., blends of PEI formed from paraphenylene diamine and from metaphenylene diamine), and so forth. Some examples of polymer components include polyetherimide (PEI) (such as ULTEM™ CRS resins commercially available from SABIC), polyphenylene ether (PPE) (such as NORYL™ resins or PPO™ resins commercially available from SABIC), polybutylene terephthalate (PBT) (such as VALOX™ resins commercially available from SABIC), polycarbonate (PC) (such as LEXAN™ resins commercially available from SABIC), as well as combinations comprising at least one of the foregoing polymer components. The polymeric component can be polyetherimide, for example the chemically resistant polyetherimide.

The polyetherimide can be analine endcapped (or endcapped with analine). The polyetherimide can be a reaction product, of 4,4′-bisphenol A dianhydride and metaphenylene diamine monomers, wherein the reaction product is endcapped with analine (i.e., analine endcapped). The polyetherimide component can be a reaction product of 4,4′-bisphenol A dianhydride and paraphenylene diamine monomers, wherein the reaction product is endcapped with analine (or analine endcapped). The polyetherimide component can be the reaction product of 4,4′-bisphenol A dianhydride, aminopropyl capped polydimethyl siloxane, and metaphenylene diamine monomers, wherein the reaction product is analine endcapped. The polyetherimide component can be a reaction product, of 4,4′-bisphenol A dianhydride and paraphenylene diamine monomers, wherein the reaction product is endcapped with phthalic anhydride (or phthalic anhydride-endcapped). The polyetherimide component can be the reaction product, of 4,4′-bisphenol A dianhydride, aminopropyl capped polydimethyl siloxane, and metaphenylene diamine monomers, wherein the reaction product is phthalic anhydride endcapped. The polyetherimide can have a Mw of greater than or equal to 5,000 Daltons (specifically, greater than or equal to 20,000 Daltons, and more specifically, greater than or equal to 60,000 Daltons) and a glass transition (Tg) temperature of 215-230° C., specifically, 220-230° C. As used herein, Tg is determined using differential scanning calorimetry (DSC), and is measured at a heating rate of 20° C./min.

The polyetherimide can be a thermoplastic resin composition including: the polyetherimide and a phosphorous-containing stabilizer. The stabilizer can be present in an amount that is effective to increase the melt stability of the polyetherimide. The phosphorous-containing stabilizer exhibits a low volatility such that, as measured by thermogravimetric analysis, greater than or equal to 10 wt % of an initial amount of a sample of the stabilizer remains unevaporated upon heating of the sample from room temperature to 300° C. at a heating rate of 20° C. per minute under an inert atmosphere.

Polyimides can comprise polyetherimides and polyetherimide copolymers. The polyetherimide can be selected from (i) polyetherimide homopolymers, e.g., polyetherimides, (ii) polyetherimide co-polymers, e.g., polyetherimide sulfones, and (iii) combinations comprising at least one of the foregoing. Polyetherimides are known polymers and are sold by SABIC under the ULTEM™, EXTEM™, and Siltem™ brands (Trademark of SABIC Innovative Plastics IP B.V.).

The polyetherimides can be of formula (1):

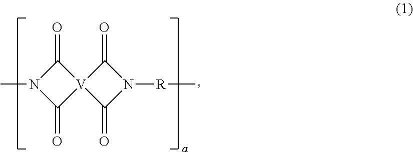

wherein a is more than 1, for example 10 to 1,000 or more, or more specifically 10 to 500.

The group V in formula (1) is a tetravalent linker containing an ether group (a “polyetherimide” as used herein) or a combination of an ether groups and arylenesulfone groups (a “polyetherimide sulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups; and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Possible additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

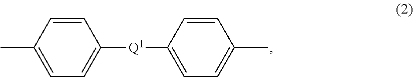

wherein Q¹ includes but is not limited to a divalent moiety such as —O—, —S—, —C(O)—, —SO₂—, —SO—, —C_{y}H_{2y}— (y being an integer from 1 to 5), and halogenated derivatives thereof, including perfluoroalkylene groups.

The linkers V include but are not limited to tetravalent aromatic groups of formula (3):

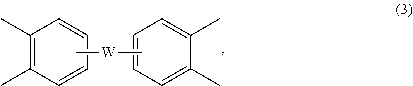

wherein W is a divalent moiety including —O—, —SO₂—, or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent groups of formulas (4):

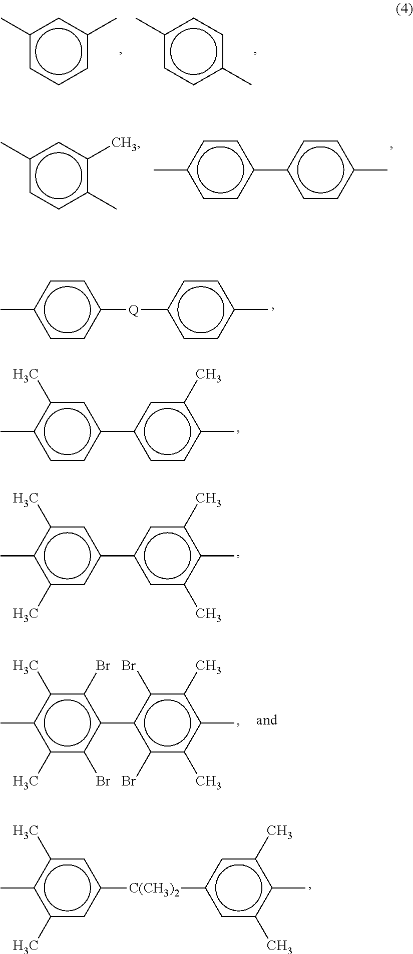

wherein Q includes, but is not limited to a divalent moiety including —O—, —S—, —C(O), —SO₂—, —SO—, —C_{y}H_{2y}— (y being an integer from 1 to 5), and halogenated derivatives thereof, including perfluoroalkylene groups.

The polyetherimide can comprise more than 1, specifically 10 to 1,000, or more specifically, 10 to 500 structural units, of formula (5):

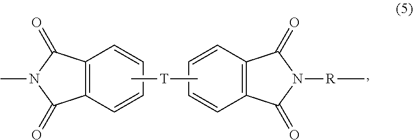

wherein T is —O— or a group of the formula —O—Z—O— wherein the divalent bonds of the —O— or the —O—Z—O— group are in the 3,3′, 3,4′, 4,3′, or the 4,4′ positions; Z is a divalent group of formula (3) as defined above; and R is a divalent group of formula (2) as defined above.

The polyetherimide sulfones can be polyetherimides comprising ether groups and sulfone groups wherein at least 50 mole % of the linkers V and the groups R in formula (1) comprise a divalent arylenesulfone group. For example, all linkers V, but no groups R, can contain an arylenesulfone group; or all groups R but no linkers V can contain an arylenesulfone group; or an arylenesulfone can be present in some fraction of the linkers V and R groups, provided that the total mole fraction of V and R groups containing an aryl sulfone group is greater than or equal to 50 mole %.

Specifically, polyetherimidesulfones can comprise more than 1, specifically 10 to 1,000, or more specifically, 10 to 500 structural units of formula (6):

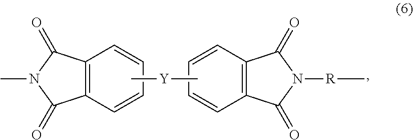

wherein Y is —O—, —SO₂—, or a group of the formula —O—Z—O— wherein the divalent bonds of the —O—, SO₂—, or the —O—Z—O— group are in the 3,3′, 3,4′, 4,3′, or the 4,4′ positions, wherein Z is a divalent group of formula (3) as defined above and R is a divalent group of formula (2) as defined above, provided that greater than 50 mole % of the sum of moles Y+moles R in formula (2) contain —SO₂— groups.

It is to be understood that the polyetherimides and polyetherimidesulfones can optionally comprise linkers V that do not contain ether or ether and sulfone groups, for example linkers of formula (7):

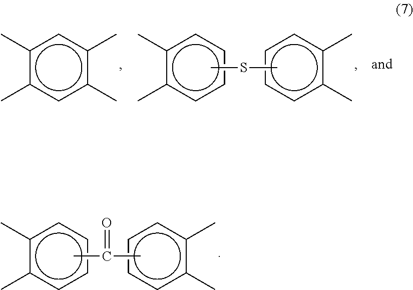

Imide units containing such linkers are generally be present in amounts ranging from 0 to 10 mole % of the total number of units, specifically 0 to 5 mole %. In one embodiment no additional linkers V are present in the polyetherimides and polyetherimidesulfones.

The polyetherimide can comprise 10 to 500 structural units of formula (5) and the polyetherimidesulfone can comprise 10 to 500 structural units of formula (6).

Polyetherimides and polyetherimide sulfones can be prepared by various processes such as polycondensation polymerization processes and halo-displacement polymerization processes.

Polycondensation methods can include a method for the preparation of polyetherimides having structure (1) is referred to as the nitro-displacement process (X is nitro in formula (8)). In one example of the nitro-displacement process, N-methyl phthalimide is nitrated with 99% nitric acid to yield a mixture of N-methyl-4-nitrophthalimide (4-NPI) and N-methyl-3-nitrophthalimide (3-NPI). After purification, the mixture, containing approximately 95 parts of 4-NPI and 5 parts of 3-NPI, is reacted in toluene with the disodium salt of bisphenol-A (BPA) in the presence of a phase transfer catalyst. This reaction yields BPA-bisimide and NaNO₂ in what is known as the nitro-displacement step. After purification, the BPA-bisimide is reacted with phthalic anhydride in an imide exchange reaction to afford BPA-dianhydride (BPADA), which in turn is reacted with a diamine such as meta-phenylene diamine (MPD) in ortho-dichlorobenzene in an imidization-polymerization step to afford the product polyetherimide.

Other diamines are also possible. Examples of diamines include: m-phenylenediamine; p-phenylenediamine; 2,4-diaminotoluene; 2,6-diaminotoluene; m-xylylenediamine; p-xylylenediamine; benzidine; 3,3′-dimethylbenzidine; 3,3′-dimethoxybenzidine; 1,5-diaminonaphthalene; bis(4-aminophenyl)methane; bis(4-aminophenyl)propane; bis(4-aminophenyl)sulfide; bis(4-aminophenyl)sulfone; bis(4-aminophenyl)ether; 4,4′-diaminodiphenylpropane; 4,4′-diaminodiphenylmethane(4,4′-methylenedianiline); 4,4′-diaminodiphenylsulfide; 4,4′-diaminodiphenylsulfone; 4,4′-diaminodiphenylether(4,4′-oxydianiline); 1,5-diaminonaphthalene; 3,3′dimethylbenzidine; 3-methylheptamethylenediamine; 4,4-dimethylheptamethylenediamine; 2,2′,3,3′-tetrahydro-3,3,3′,3′-tetramethyl-1,1′-spirobi[1H-indene]-6,6′-diamine; 3,3′,4,4′-tetrahydro-4,4,4′,4′-tetramethyl-2,2′-spirobi[2H-1-benzo-pyran]-7,7′-diamine; 1,1′-bis[1-amino-2-methyl-4-phenyl]cyclohexane, and isomers thereof as well as mixtures and blends comprising at least one of the foregoing. In one embodiment, the diamines are specifically aromatic diamines, especially m- and p-phenylenediamine and mixtures comprising at least one of the foregoing.

Dianhydrides that can be used with the diamines include and are not limited to 2,2-bis[4-(3,4-dicarboxyphenoxy)phenyl]propane dianhydride; 4,4′-bis(3,4-dicarboxyphenoxy) diphenyletherdianhydride; 4,4′-bis(3,4-dicarboxyphenoxy)diphenylsulfidedianhydride; 4,4′-bis(3,4-dicarboxyphenoxy) benzophenonedianhydride; 4,4′-bis(3,4-dicarboxyphenoxy) diphenylsulfonedianhydride; 2,2-bis[4-(2,3-dicarboxyphenoxy)phenyl]propane dianhydride; 4,4′-bis(2,3-dicarboxyphenoxy)diphenyletherdianhydride; 4,4′-bis(2,3-dicarboxyphenoxy) diphenylsulfidedianhydride; 4,4′-bis(2,3-dicarboxyphenoxy) benzophenonedianhydride; 4,4′-bis(2,3-dicarboxyphenoxy)diphenylsulfonedianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyletherdianhydride; 4-(2,3-dicarboxyphenoxy)-4′-(3,4-dicarboxyphenoxy)diphenylsulfide dianhydride; 4-(2,3-dicarboxyphenoxy)-4′-(3,4-dicarboxyphenoxy)benzophenonedianhydride; 4-(2,3-dicarboxyphenoxy)-4′-(3,4-dicarboxyphenoxy)diphenylsulfone dianhydride; 1,3-bis(2,3-dicarboxyphenoxy)benzene dianhydride; 1,4-bis(2,3-dicarboxyphenoxy)benzene dianhydride; 1,3-bis(3,4-dicarboxyphenoxy)benzene dianhydride; 1,4-bis(3,4-dicarboxyphenoxy)benzene dianhydride; 3,3′,4,4′-diphenyl tetracarboxylicdianhydride; 3,3′,4,4′-benzophenonetetracarboxylic dianhydride; naphthalicdianhydrides, such as 2,3,6,7-naphthalic dianhydride, etc.; 3,3′,4,4′-biphenylsulphonictetracarboxylic dianhydride; 3,3′,4,4′-biphenylethertetracarboxylic dianhydride; 3,3′,4,4′-dimethyldiphenylsilanetetracarboxylic dianhydride; 4,4′-bis (3,4-dicarboxyphenoxy) diphenylsulfidedianhydride; 4,4′-bis (3,4-dicarboxyphenoxy)diphenylsulphonedianhydride; 4,4′-bis (3,4-dicarboxyphenoxy)diphenylpropanedianhydride; 3,3′,4,4′-biphenyltetracarboxylic dianhydride; bis(phthalic)phenylsulphineoxidedianhydride; p-phenylene-bis(triphenylphthalic) dianhydride; m-phenylene-bis(triphenylphthalic)dianhydride; bis(triphenylphthalic)-4,4′-diphenylether dianhydride; bis(triphenylphthalic)-4,4′-diphenylmethane dianhydride; 2,2′-bis(3,4-dicarboxyphenyl)hexafluoropropanedianhydride; 4,4′-oxydiphthalic dianhydride; pyromelliticdianhydride; 3,3′,4,4′-diphenylsulfonetetracarboxylic dianhydride; 4′,4′-bisphenol A dianhydride; hydroquinone diphthalic dianhydride; 6,6′-bis(3,4-dicarboxyphenoxy)-2,2′,3,3′-tetrahydro-3,3,3′,3′-tetramethyl-1,1′-spirobi[1H-indene]dianhydride; 7,7′-bis(3,4-dicarboxyphenoxy)-3,3′,4,4′-tetrahydro-4,4,4′,4′-tetramethyl-2,2′-spirobi[2H-1-benzopyran]dianhydride; 1,1′-bis[1-(3,4-dicarboxyphenoxy)-2-methyl-4-phenyl]cyclohexane dianhydride; 3,3′,4,4′-diphenylsulfonetetracarboxylic dianhydride; 3,3′,4,4′-diphenylsulfidetetracarboxylic dianhydride; 3,3′,4,4′-diphenylsulfoxidetetracarboxylic dianhydride; 4,4′-oxydiphthalic dianhydride; 3,4′-oxydiphthalic dianhydride; 3,3′-oxydiphthalic dianhydride; 3,3′-benzophenonetetracarboxylic dianhydride; 4,4′-carbonyldiphthalic dianhydride; 3,3′,4,4′-diphenylmethanetetracarboxylic dianhydride; 2,2-bis(4-(3,3-dicarboxyphenyl)propane dianhydride; 2,2-bis(4-(3,3-dicarboxyphenyl)hexafluoropropanedianhydride; (3,3′,4,4′-diphenyl)phenylphosphinetetracarboxylicdianhydride; (3,3′,4,4′-diphenyl) phenylphosphineoxidetetracarboxylicdianhydride; 2,2′-dichloro-3,3′,4,4′-biphenyltetracarboxylic dianhydride; 2,2′-dimethyl-3,3′,4,4′-biphenyltetracarboxylic dianhydride; 2,2′-dicyano-3,3′,4,4′-biphenyltetracarboxylic dianhydride; 2,2′-dibromo-3,3′,4,4′-biphenyltetracarboxylic dianhydride; 2,2′-diiodo-3,3′,4,4′-biphenyltetracarboxylic dianhydride; 2,2′-ditrifluoromethyl-3,3′,4,4′-biphenyltetracarboxylic dianhydride; 2,2′-bis(1-methyl-4-phenyl)-3,3′,4,4′-biphenyltetracarboxylic dianhydride; 2,2′-bis(1-trifluoromethyl-2-phenyl)-3,3′,4,4′-biphenyltetracarboxylic dianhydride; 2,2′-bis(1-trifluoromethyl-3-phenyl)-3,3′,4,4′-biphenyltetracarboxylic dianhydride; 2,2′-bis(1-trifluoromethyl-4-phenyl)-3,3′,4,4′-biphenyltetracarboxylic dianhydride; 2,2′-bis(1-phenyl-4-phenyl)-3,3′,4,4′-biphenyltetracarboxylic dianhydride; 4,4′-bisphenol A dianhydride; 3,4′-bisphenol A dianhydride; 3,3′-bisphenol A dianhydride; 3,3′,4,4′-diphenylsulfoxidetetracarboxylic dianhydride; 4,4′-carbonyldiphthalic dianhydride; 3,3′,4,4′-diphenylmethanetetracarboxylic dianhydride; 2,2′-bis(1,3-trifluoromethyl-4-phenyl)-3,3′,4,4′-biphenyltetracarboxylic dianhydride, and all isomers thereof, as well as combinations of the foregoing.

Halo-displacement polymerization methods for making polyetherimides and polyetherimide sulfones include and are not limited to, the reaction of a bis(phthalimide) for formula (8):

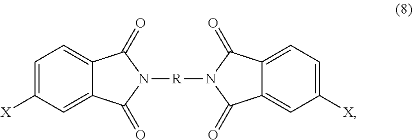

wherein R is as described above and X is a nitro group or a halogen. Bis-phthalimides (8) can be formed, for example, by the condensation of the corresponding anhydride of formula (9):

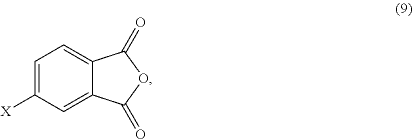

wherein X is a nitro group or halogen, with an organic diamine of the formula (10):

H₂N—R—NH₂ (10),

wherein R is as described above.

Illustrative examples of amine compounds of formula (10) include: ethylenediamine, propylenediamine, trimethylenediamine, diethylenetriamine, triethylenetetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3, 5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1, 3-diamino-4-isopropylbenzene, bis(4-aminophenyl) ether and 1,3-bis(3-aminopropyl) tetramethyldisiloxane. Mixtures of these amines can be used. Illustrative examples of amine compounds of formula (10) containing sulfone groups include but are not limited to, diaminodiphenylsulfone (DDS) and bis(aminophenoxy phenyl) sulfones (BAPS). Combinations comprising any of the foregoing amines can be used.

The polyetherimides can be synthesized by the reaction of the bis(phthalimide) (8) with an alkali metal salt of a dihydroxy substituted aromatic hydrocarbon of the formula HO—V—OH wherein V is as described above, in the presence or absence of phase transfer catalyst. Examples of phase transfer catalysts are disclosed in U.S. Pat. No. 5,229,482. Specifically, the dihydroxy substituted aromatic hydrocarbon a bisphenol such as bisphenol A, or a combination of an alkali metal salt of a bisphenol and an alkali metal salt of another dihydroxy substituted aromatic hydrocarbon can be used.

The polyetherimide can comprise structural units of formula (5) wherein each R is independently p-phenylene or m-phenylene or a mixture comprising at least one of the foregoing; and T is group of the formula —O—Z—O— wherein the divalent bonds of the —O—Z—O— group are in the 3,3′ positions, and Z is 2,2-diphenylenepropane group (a bisphenol A group). Further, the polyetherimidesulfone can comprise structural units of formula (6) wherein at least 50 mole % of the R groups are of formula (4) wherein Q is —SO₂— and the remaining R groups are independently p-phenylene or m-phenylene or a combination comprising at least one of the foregoing; and T is group of the formula —O—Z—O— wherein the divalent bonds of the —O—Z—O— group are in the 3,3′ positions, and Z is a 2,2-diphenylenepropane group.

The polyetherimide and polyetherimide sulfone can be used alone or in combination with each other and/or with other of the disclosed polymeric materials in fabricating polymeric components. In one embodiment, only the polyetherimide is used. In another embodiment, the weight ratio of polyetherimide:polyetherimidesulfone can be from 99:1 to 50:50.

The polyetherimides can have a weight average molecular weight (Mw) of 5,000 to 100,000 Daltons as measured by gel permeation chromatography (GPC). In some embodiments the Mw can be 10,000 to 80,000. The molecular weights as used herein refer to the absolute weight averaged molecular weight (Mw).

The polyetherimides can have an intrinsic viscosity greater than or equal to 0.2 deciliters per gram (dl/g) as measured in m-cresol at 25° C. Within this range the intrinsic viscosity can be 0.35 to 1.0 dl/g, as measured in m-cresol at 25° C.

The polyetherimides can have a glass transition temperature of greater than 180° C., specifically of 200° C. to 500° C., as measured using differential scanning calorimetry (DSC) per ASTM test D3418. In some embodiments, the polyetherimide and, in particular, a polyetherimide has a glass transition temperature of 240 to 350° C.

The polyetherimides can have a melt index of 0.1 to 10 grams per minute (g/min), as measured by American Society for Testing Materials (ASTM) DI 238 at 340 to 370° C., using a 6.7 kilogram (kg) weight.

One halo-displacement polymerization process for making polyetherimides, (e.g., polyetherimides having structure (1)) is a process referred to as the chloro-displacement process (e.g., X is Cl in formula (8)). The chloro-displacement process is illustrated as follows: 4-chloro phthalic anhydride and meta-phenylene diamine are reacted in the presence of a catalytic amount of sodium phenyl phosphinate catalyst to produce the bischlorophthalimide of meta-phenylene diamine (CAS No. 148935-94-8). The bischlorophthalimide is then subjected to polymerization by chloro-displacement reaction with the disodium salt of BPA in the presence of a catalyst in ortho-dichlorobenzene or anisole solvent. Alternatively, mixtures of 3-chloro- and 4-chlorophthalic anhydride may be employed to provide a mixture of isomeric bischlorophthalimides which may be polymerized by chloro-displacement with BPA disodium salt as described above.

Siloxane polyetherimides can include polysiloxane/polyetherimide block copolymers having a siloxane content of greater than 0 and less than 40 weight percent (wt %) based on the total weight of the block copolymer. The block copolymer comprises a siloxane block of Formula (I):

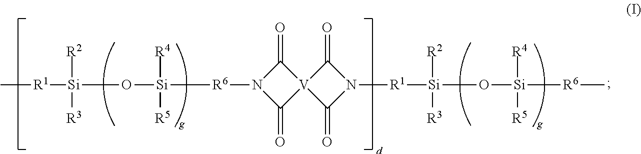

wherein R¹⁻⁶ are independently at each occurrence selected from substituted or unsubstituted, saturated, unsaturated, or aromatic monocyclic groups having 5 to 30 carbon atoms, substituted or unsubstituted, saturated, unsaturated, or aromatic polycyclic groups having 5 to 30 carbon atoms, substituted or unsubstituted alkyl groups having 1 to 30 carbon atoms and substituted or unsubstituted alkenyl groups having 2 to 30 carbon atoms, V is a tetravalent linker selected from the group consisting of substituted or unsubstituted, saturated, unsaturated, or aromatic monocyclic and polycyclic groups having 5 to 50 carbon atoms, substituted or unsubstituted alkyl groups having 1 to 30 carbon atoms, substituted or unsubstituted alkenyl groups having 2 to 30 carbon atoms and combinations comprising at least one of the foregoing linkers, g equals 1 to 30, and d is 2 to 20. Commercially available siloxane polyetherimides can be obtained from SABIC Innovative Plastics under the brand name SILTEM™.

The polyetherimide resin can have a weight average molecular weight (Mw) from 5,000 to 100,000 Daltons, from 5,000 to 70,000 Daltons, or from 5,000 to 60,000 Daltons, or 60,000 to 100,000 Daltons, specifically, 70,000 to 100,000 Daltons.

The polyetherimide resin can be selected from, for example a polyetherimide as described in U.S. Pat. Nos. 3,875,116, 6,919,422, and 6,355,723; a silicone polyetherimide, for example as described in U.S. Pat. Nos. 4,690,997, and 4,808,686; a polyetherimide sulfone resin, as described in U.S. Pat. No. 7,041,773; and combinations comprising at least one of the foregoing.

The polyetherimide resin can have a glass transition temperature of greater than 200 degrees Celsius (° C.). The polyetherimide resin can be substantially free (less than 100 ppm) of benzylic protons. The polyetherimide resin can be free of benzylic protons. The polyetherimide resin can have an amount of benzylic protons below 100 ppm. In one embodiment, the amount of benzylic protons ranges from more than 0 to below 100 ppm. In another embodiment, the amount of benzylic protons is not detectable based upon currently available detections techniques as of October 2014.

The polyetherimide resin can be substantially free (less than 100 ppm) of halogen atoms. The polyetherimide resin can be free of halogen atoms. The polyetherimide resin can have an amount of halogen atoms below 100 ppm. In one embodiment, the amount of halogen atoms range from more than 0 to below 100 ppm. In another embodiment, the amount of halogen atoms is not detectable based upon currently available detections techniques as of October 2014.

Examples of polyetherimides that can be used in the disclosed compositions include, but are not limited to, ULTEM™. ULTEM™ is a polymer from the family of polyetherimides sold by SABIC. ULTEM™ as used herein refers to any or all ULTEM™ polymers included in the family unless otherwise specified. The polyetherimide can, for example, be in a composition which can further comprise any polycarbonate material or mixture of materials, for example, as recited in U.S. Pat. No. 4,548,997; U.S. Pat. No. 4,629,759; U.S. Pat. No. 4,816,527; U.S. Pat. No. 6,310,145; and U.S. Pat. No. 7,230,066. The polyetherimide can, for example, be in a composition which can further comprise any polyester material or mixture of materials, for example, as recited in U.S. Pat. No. 4,141,927; U.S. Pat. No. 6,063,874; U.S. Pat. No. 6,150,473; and U.S. Pat. No. 6,204,340.

The polyetherimide can have a structure comprising structural units represented by an organic radical of formula (I):

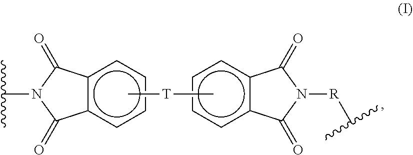

wherein R in formula (I) includes substituted or unsubstituted divalent organic radicals such as (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, or (d) divalent radicals of the general formula (II):

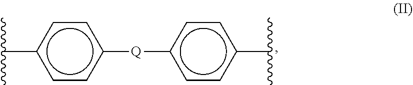

wherein Q includes a divalent moiety selected from the group consisting of a single bond, —O—, —S—, —C(O)—, —SO₂—, —SO—, —CyH₂y- (y being an integer from 1 to 5), and halogenated derivatives thereof, including perfluoroalkylene groups; wherein T is —O— or a group of the formula —O—Z—O— wherein the divalent bonds of the —O— or the —O—Z—O— group are in the 3,3′, 3,4′, 4,3′, or the 4,4′ positions, and wherein Z includes, but is not limited, to divalent radicals of formula (III):

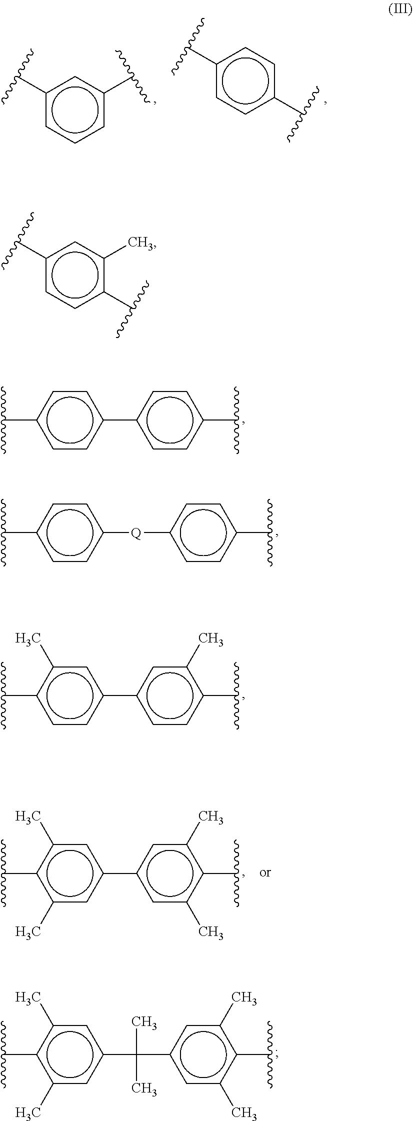

wherein the polyetherimides which are included by formula (I) have a Mw of at least 40,000.

In a further aspect, the polyetherimide polymer may be a copolymer, which, in addition to the etherimide units described above, further contains polyimide structural units of the formula (IV):

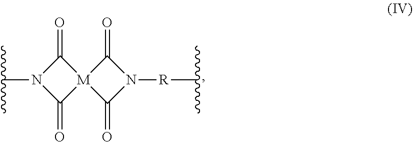

wherein R is as previously defined for formula (I) and M includes, but is not limited to, radicals of formula (V):

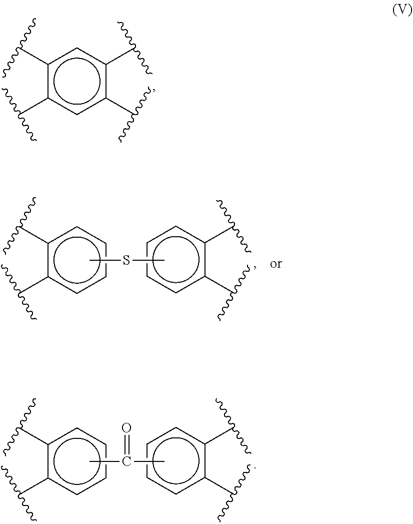

In a further aspect, the thermoplastic resin is a polyetherimide polymer having structure represented by a formula:

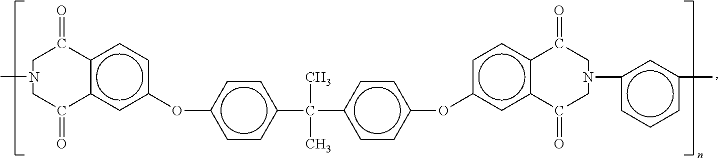

wherein the polyetherimide polymer has a molecular weight of at least 40,000 Daltons, at least 50,000 Daltons, at least 60,000 Daltons, at least 80,000 Daltons, or at least 100,000 Daltons.

The polyetherimide polymer can be prepared by methods known to one skilled in the art, including the reaction of an aromatic bis(ether anhydride) of the formula (VI):

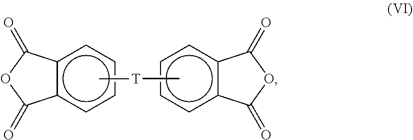

with an organic diamine of the formula (IX):

H₂N—R—NH₂ (VII),

wherein T and R are defined as described above in formula (I).

Illustrative, non-limiting examples of aromatic bis(ether anhydride)s of formula (VI) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy) benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s can be prepared by the hydrolysis, followed by dehydration, of the reaction product of a nitro substituted phenyl dinitrile with a metal salt of dihydric phenol compound in the presence of a dipolar, aprotic solvent. A useful class of aromatic bis(ether anhydride)s included by formula (VI) above includes, but is not limited to, compounds wherein T is of the formula (VIII):

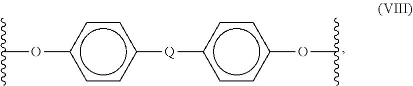

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Illustrative, non-limiting examples of diamino compounds of formula (VII) include ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecane diamine, 1,18-octadecanediamine, 3-methylheptamethylenediamine, 4,4-dimethylheptamethylenediamine, 4-methylnonamethylenediamine, 5-methylnonamethylene diamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylene diamine, 1,2-bis(3-aminopropoxy) ethane, bis(3-aminopropyl) sulfide, 1,4-cyclohexane diamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3, 5-diethylphenyl) methane, bis(4-aminophenyl) propane, 2,4-bis(b-amino-t-butyl) toluene, bis(p-b-amino-t-butylphenyl) ether, bis(p-b-methyl-o-aminophenyl) benzene, bis(p-b-methyl-o-aminopentyl) benzene, 1, 3-diamino-4-isopropyl benzene, bis(4-aminophenyl) sulfide, bis (4-aminophenyl) sulfone, bis(4-aminophenyl) ether and 1,3-bis(3-aminopropyl) tetramethyldisiloxane. Mixtures of these compounds may also be present. Beneficial diamino compounds are aromatic diamines, especially m- and p-phenylenediamine and mixtures thereof.

The polyetherimide resin can include structural units according to formula (I) wherein each R is independently p-phenylene or m-phenylene or a mixture thereof and T is a divalent radical of the formula (IX):

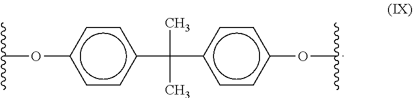

The reactions can be carried out employing solvents such as o-dichlorobenzene, m-cresol/toluene, or the like, to effect a reaction between the anhydride of formula (VI) and the diamine of formula (VII), at temperatures of 100° C. to 250° C. Alternatively, the polyetherimide can be prepared by melt polymerization of aromatic bis(ether anhydride)s of formula (VI) and diamines of formula (VII) by heating a mixture of the starting materials to elevated temperatures with concurrent stirring. Melt polymerizations can employ temperatures of 200° C. to 400° C. Chain stoppers and branching agents can also be employed in the reaction. The polyetherimide polymers can optionally be prepared from reaction of an aromatic bis(ether anhydride) with an organic diamine in which the diamine is present in the reaction mixture at no more than 0.2 molar excess, and beneficially less than 0.2 molar excess. Under such conditions the polyetherimide resin has less than 15 microequivalents per gram (μeq/g) acid titratable groups in one embodiment, and less than 10 μeq/g acid titratable groups in an alternative embodiment, as shown by titration with chloroform solution with a solution of 33 weight percent (wt %) hydrobromic acid in glacial acetic acid. Acid-titratable groups are essentially due to amine end-groups in the polyetherimide resin.

The poly(phenylene ether) component can include repeating structural units having the formula:

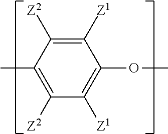

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and wherein each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

The poly(phenylene ether)-polysiloxane block copolymer can be prepared by an oxidative copolymerization method. The poly(phenylene ether) component can include a homopolymer or copolymer of monomers such as 2,6 dimethylphenol, 2,3,6 trimethylphenol, and combinations comprising at least one of the foregoing.

The polycarbonate component can include a polycarbonate copolymer including bisphenol A carbonate units and units of the formula:

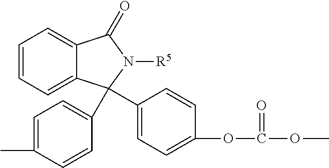

wherein R⁵ is hydrogen, phenyl optionally substituted with up to five C₁₋₁₀ alkyl groups, or C₁₋₄ alkyl. The polycarbonate component can include a poly(carbonate-siloxane) including bisphenol A carbonate units, and siloxane units of the formula:

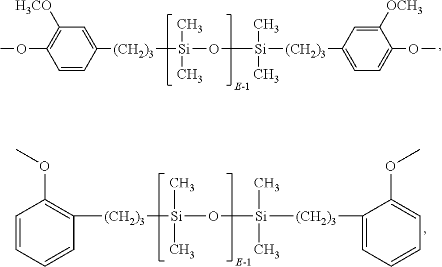

or a combination including at least one of the foregoing, wherein E has an average value of 2 to 200, wherein the poly(carbonate-siloxane) comprises 0.5 to 55 wt. % of siloxane units based on the total weight of the poly(carbonate-siloxane). The polycarbonate component can be a bisphenol polycarbonate. The polycarbonate component can be in the form of a solution of the polycarbonate component in a solvent.

The polymer is dissolved in a solvent. The specific solvent chosen is based upon the particular polymer and the solubility of that polymer in the solvent. Solubility of the polymer in the solvent should be greater than 5 grams per liter (g/L) at the stability temperature, and desirably would be complete at the stability temperature. Another consideration is the compatibility of the solvent with the dispersion medium and whether facile separation, such as via distillation, of the solvent from the dispersion medium is possible. Facile separation will allow recycling of the solvent and of the dispersion medium and hence will further render the process more commercially viable. The solvent may comprise meta-cresol, veratrol, ortho-dichlorobenzene (ODCB), N-methyl pyrrolidone (NMP), chloroform, tetrahydrofuran (THF), dimethylformamide (DMF), dichloromethane (DCM) dimethylacetamide (DMAc), dimethyl carbonate (DMC), diethyl carbonate (DEC), ethyl methyl carbonate (EMC), ethylene carbonate (EC), dimethyl sulfoxide (DMSO), hexafluoro-2-propanol (HFIP), trichloroethane (TCHE), tetrachloroethane, trifluoroacetic acid (TFA), phenol (e.g., 4-chloro-3-methyl-phenol, 4-chloro-2-methyl-phenol, 2,4-dichloro-6-methyl-phenol, 2,4-dichloro-phenol, 2,6-dichloro-phenol, 4-chloro-phenol, 2-chloro-phenol, 4-methoxy-phenol), cresol (e.g., ortho-cresol, meta-cresol, para-cresol), benzoquinone, xylenol (e.g., 2,3-xylenol, 2,6-xylenol), dihydroxybenzene (e.g., catechol, resorcinol), N-Ethyl-2-pyrrolidone (NEP), 1-Ethenyl-2-pyrrolidone (NVP), 2-Pyrrolidone (2-Py), 1,3-Dimethyl-2-imidazolidinone (DMI), N,N-dimethylformamide (DMF), N,N-dimethylacetamide (DMAc), dimethyl sulfoxide (DMSO), dipropylene glycol dimethyl ether (DPGME), and combinations comprising at least one of the foregoing. For chemically resistant PEI (e.g., formed from (i) paraphenylene diamine monomers and phthalic anhydride endcapped or (ii) paraphenylene diamine monomers and analine endcapped), for example, the solvent can be NMP, DCM/HFIP (e.g., in 1:1 ratio), chloroform/DCM/HFIP, Chloroform/HFIP/toluene (e.g., in 37/37/25 proportions), DCM/HFIP/4-Cl-cresol, Chloroform/HFIP (e.g., 90/10), Chloroform/HFIP (e.g., 50/50), HFIP/DCM (e.g., 50/50), TFA/4-Cl-resol (e.g., 50/50), 2-Cl-phenol/HFIP (e.g., 50/50 and 80/20), DCM/4-Cl-cresol (e.g., 50/50), DCM/2-Cl-cresol (e.g., 50/50), 4-Cl-cresol, 2-Cl-cresol, and cresol/Cl-cresol. For example, the solvent can comprise NEP, NVP, 2-Py, DMI, DMF, DMAc, DMSO, DPGME, NMP, or a combination comprising at least one of the foregoing. Optionally, the solvent comprises DMI, DMF, DMAc, DMSO, DPGME, NMP, or a combination comprising at least one of the foregoing; or specifically, the solvent comprises NMP.

Precipitation of the polymer occurs in the dispersion medium. Therefore, the dispersion medium comprises the anti-solvent. As used herein, the anti-solvent is a material that induces precipitation of the polymer, when the anti-solvent and polymer solution are combined. In other words, the polymer is insoluble in the anti-solvent (has a solubility in the anti-solvent of less than 2 g/L at the operating temperature of the dispersion medium, specifically less than or equal to 1 g/L, more specifically less than or equal to 0.5 g/L, and most specifically, less than or equal to 0.1 g/L).

Examples of anti-solvents include water, ethyl alcohol, propyl glycol, propylene glycol, glycerin, and combinations comprising at least one of the foregoing, such as water and ethyl alcohol. For example, the anti-solvent can be water. For example the anti-solvent can be water, ethyl alcohol, and glycerin. The dispersion medium can further include a carrier, such as glycerin, cresol, tetrachloroethane, HFIP, meta-cresol, veratrol, ortho-dichlorobenzene (ODCB), N-methyl pyrrolidone (NMP), chloroform, tetrahydrofuran (THF), dimethylformamide (DMF) and dimethylacetamide (DCM), N-Ethyl-2-pyrrolidone (NEP), 1-Ethenyl-2-pyrrolidone (NVP), 2-Pyrrolidone (2-Py), 1,3-Dimethyl-2-imidazolidinone (DMI), N,N-dimethylacetamide (DMAc), dimethyl sulfoxide (DMSO), dipropylene glycol dimethyl ether (DPGME), and combinations comprising at least one of the foregoing. For example, the carrier can be NMP. Not to be bound by theory, these materials can be employed to decrease the rate of precipitation to allow for fiber formation instead of resin clumping. For example, the dispersion medium can comprise greater than or equal to 90 wt % carrier and less than or equal to 10 wt % anti-solvent (e.g., water) (i.e., 90 wt % to less than 100 wt % carrier and greater than 0 wt % to 10 wt % anti-solvent), e.g., 92 wt % to 98 wt % carrier and less than or equal 2 wt % to 8 wt % anti-solvent, specifically, 92 wt % to 97 wt % carrier and less than or equal 3 wt % to 8 wt % anti-solvent. For example, the anti-solvent can comprise greater than or equal to 90 wt % NMP and less than or equal to 10 wt % water, e.g., 92 wt % to 98 wt % NMP and less than or equal 2 wt % to 8 wt % water, specifically, 92 wt % to 97 wt % NMP and less than or equal 3 wt % to 8 wt % water.

Optionally, the viscosity of the dispersion medium can be increased, e.g., to increase the shear stress when forming the fibers and thereby facilitate the formation of thinner fibers. The dispersion medium viscosity can be increased using at least one of the foregoing: adding particles, such as adding sub-micron particles (e.g., having an average major axis (i.e., the longest axis) of less than 1 Gm) and/or nanoparticles having an average major axis of less than or equal to 100 nm; dissolving a salt in the dispersion medium, reducing the temperature of the dispersion medium, dissolving sodium alginate in the dispersion medium, and dissolving a polymer in the dispersion medium. The average major axis can be determined using, for example, a scanning electron microscope (SEM). Examples of possible submicron particles include aluminum oxide (AL₂O₃), sodium dioxide (SiO₂), and combinations comprising at least one of the foregoing. Examples of salts include lithium chloride salt and lithium bromide. Possible salts include those that can be dissolved in a dispersion medium comprising a water anti-solvent (and used with a polymer solution comprising NMP). Examples of polymers that can be dissolved in the dispersion medium include polyvinylpyrrolidone (PVP) and polyethylene glycol (PEG). Another polymer that can be dissolved in the dispersion medium is polyvinyl alcohol (PVA). For example, when forming fibers having a specified average fiber diameter, the viscosity of the dispersion medium can be increased by adding greater than 0 to 15 wt % particles, wherein the particles have a diameter that is less than or equal to 0.75 nm (specified average fiber diameter), specifically, that is less than or equal to 0.5 nm (specified average fiber diameter), and more specifically, that is less than or equal to 0.25 nm*(specified average fiber diameter).

Since this process can be used without nozzles the incorporation of additives can be accomplished without the risk of clogging a nozzle or unduly increasing the operating pressure. Examples of possible additives include ceramics (such as titania, alumina, zirconia and various clays, silica, glasses, bioceramics, bioactive glasses), metals (e.g., silver, gold, etc.), metal alloys, metal oxides, metalloids (e.g., silicon, germanium, semiconductor and quantum dot forming materials etc.) and their oxides, graphite, carbon black, various graphene nanosheets and carbon nanotubes (CNTs). Additives may be included for various purposes such as imparting to or enhancing a property or function of the nanofiber, for example strength, anti-bacterial activity, therapeutic activity (e.g., pharmaceutical drug crystals), conductivity, semiconductivity (e.g., quantum dots, semiconductor nanoparticles), magnetic behavior, porosity, hydrophobicity, selective permeability, selective affinity to various materials, adhesiveness, enzymatic or catalytic activity, biocompatibility, biodegradability, biological adhesion, biological recognition and/or binding, chemical inertness, polarity, selective retention and/or enrichment of analytes in analytical separation techniques, colorants (e.g., fluorescent dyes and pigments), odorants, deodorants, plasticizers, impact modifiers, fillers, nucleating agents, lubricants, surfactants, wetting agents, flame retardants, ultraviolet light stabilizers, antioxidants, biocides, thickening agents, heat stabilizers, defoaming agents, blowing agents, emulsifiers, crosslinking agents, waxes, particulates, flow promoters, as well as combinations comprising at least one of the foregoing. The additives can be added to the polymer solution, the dispersion medium, or both. These additives can be added before, during or after formation of the polymer dispersion and/or formation of the polymer fibers. In certain embodiments, a surfactant, such as a nonionic or anionic surfactant, is added to a solution comprising the fibers in order to enhance dispersion of the fibers in the solution, particularly where the fibers are in an aqueous solution. Optionally, the fibers can be provided with an additional functionality imparting therapeutic activity, catalytic activity, microelectronic activity, micro-optoelectronic activity, magnetic activity, biological activity, and combinations comprising at least one of the foregoing.

The additive can be added via at least one of the foregoing methods 1) into the polymer pellet/powder prior to dissolving in the solvent, 2) added to the solvent when dissolving the polymer, 3) having an injection point in the polymer-solvent injection line to feed in a controlled amount of additive, and 4) added to the dispersion medium. For example, the additive can be added to the polymer solution prior to mixing with the dispersion medium.

The polymer solution can, at room temperature, have a viscosity of up to 300,000 centipoise (cP), for example, 1 to 40,000 cP, or 50 to 20,000 cP, or 100 to 2,500 cP, or even 150 to 1,000 cP. For example, the polymer solution can have a viscosity of from 50 to 100 cP.

The dispersion medium can, at room temperature, have a viscosity of up to 100,000 centipoise (cP), for example, 1 to 2,500 cP, or 10 to 1,500 cP, or 30 to 500 cP, or even 40 to 250 cP. For example, the dispersion medium can have a viscosity of from 50 to 100 cP.

Once the polymer solution is formed, the temperature is adjusted to the stability temperature. Desirably, if the stability temperature is below room temperature, the polymer solution is maintained at or below the stability temperature, and if the stability temperature is above room temperature, the polymer solution is maintained at or above the stability temperature, until the polymer solution is combined with the dispersion medium. For example, the polymer solution can be adjusted to a temperature of greater than or equal to 30° C. to below the boiling point of the solvent(s) in which the polymer will be dissolved, specifically 40° C. to 10° C. below the boiling point, and more specifically, 50° C. to 10° C. below the boiling point. (In other words, if the boiling point of the solvent is 200° C., 10° C. below the boiling point would be 190° C.) Alternatively, the temperature of the polymer solution can be adjusted to below room temperature (e.g., below 25° C.). For example, the polymer solution can be adjusted to a temperature of above the freezing point of the solvent to 20° C., specifically 5° C. above the freezing point of the solvent to 20° C., and more specifically, 10° C. above the freezing point of the solvent to 15° C. (In other words, if the freezing point of the solvent is −40° C., 5° C. above the freezing point would be −35° C.) The specific desired temperature can readily be determined by combining the polymer and the solvent to form a polymer solution and adjusting the temperature of the polymer solution. If the polymer remains in solution, the stability temperature has been determined. The polymer solution can then be maintained at the stability temperature until the solution is combined with a dispersion medium.

Maintaining the temperature of the polymer solution can be attained in any available fashion. For example, the temperature can be adjusted and maintained using one or more of the foregoing: 1) maintaining the polymer solution supply, injection tube, and injection point at the stability temperature; 2) using a thermal blanket (e.g., heating blanket); adjusting the temperature of the polymer solution using a heat exchanger (e.g., an oil bath, a dope tank, heat plate, and the like); 3) a controller with a control loop and temperature sensor(s); 4) heat exchanger(s).

The temperature of the dispersion medium can be adjusted and maintained in a similar manner as the polymer solution. The dispersion medium can have a temperature adjusted from room temperature, e.g., increased to greater than 30° C. to less than the boiling point of the dispersion medium, for example, 30° C. to 150° C., specifically, 30° C. to 100° C., or 40° C. to 80° C. Controlling the temperature of the dispersion medium can result in control over the precipitation rate when the polymer solution is combined with the dispersion medium. As a result, the size of the fibers can be controlled.

As the dispersion medium and the polymer solution are combined (e.g., as the polymer solution is added to the dispersion medium) to form a polymer dispersion, a shear stress is applied to the polymer dispersion. The shear stress can be up to 1,500 Pascals (Pa), for example, 10 Pa to 1,000 Pa, or 20 to 500 Pa, or 30 to 100 Pa. The process can operate at a spinning rate sufficient to provide the desired shear stress and hence the desired fiber size. For example, the spinning rate can be greater than or equal to 300 grams per hour (g/hr), or greater than or equal to 7,000 g/hr; e.g., 300 to 100,000 g/hr, specifically 2,000 to 95,000 g/hr, and more specifically, 7,000 to 80,000 g/hr.

Optionally, the rate of precipitation of the polymer in the polymer dispersion can be controlled by controlling the temperature of the combination and gradually adjusting the temperature toward room temperature. For example, for polyetherimide having a Tg of greater than 220° C., the polymer dispersion can be at a temperature of 30° C. to 100° C. to control the rate of precipitation.

Once the fibers have been formed, they can be separated from the polymer dispersion and can optionally be washed (utilizing, for example, an anti-solvent) to remove the solvent and then filtered, e.g., using a filter press. The fibers can then be collected, while still wet, e.g., and sent for wet-laid nonwoven formation. Alternatively, the fibers can be dried and collected, e.g., for shipping. Optionally the solvent can be partially removed from the fibers (e.g., to allow the fibers to at least one of solidify, and to control the pH).

Depending upon the type of fibers (e.g., composite inorganic/polymer fibers), the fibers may then be subjected to calcination and/or organics removal process to release (or liberate) the inorganic fibrils from the nanofibers. In this manner, the inorganic fibrils may be provided as an end product. Calcination may be performed in any device (furnace, kiln, fluidized bed reactor, etc.) configured for implementing calcination. The temperature at which calcination is carried out and the total time of calcination will depend on the type of polymer and inorganic compound utilized, and generally should be sufficient to vaporize the polymer fraction without thermally decomposing the inorganic fibrils.

Each of the plurality of polymeric fibers can have a length to diameter ratio of 10 to 1,000,000, e.g., 100 to 950,000, or 10 to 50,000, or 10,000 to 900,000. Optionally, the fibers can be cut to a desired length. Each of the plurality of polymeric fibers can have an average diameter of up to 6 μm, e.g., 0.1 to 5.5 μm, specifically, 0.3 to 5 μm, more specifically, 0.5 to 5 μm, and even 0.5 to less than 1 μm. As used herein distributions of fiber diameters (e.g., average diameter) were measured by imaging the sample using a Phenom Pro Desktop, scanning electron microscope (SEM) using a minimum magnification of 130×, with a minimum of 4 images retained for fiber diameter analysis. Fiber diameter analysis software (e.g., Fibermetric software) is used to measure the sample's images with at least 20 measurements per image, which are randomly selected by the software, are used in determining the average fiber diameter and distribution.

The produced fibers can be used in various processes. For example, the process can further include producing a non-woven web comprising the plurality of the fibers. Producing the non-woven web can include depositing the plurality of the fibers onto a carrier substrate (e.g., reciprocating belt), a functional substrate, a film, a non-woven web, a rolled good product (e.g., film, filter media, substrates, cellulose based paper, and other product sold in rolled form), and combinations comprising at least one of the foregoing. The process can further include solidifying the plurality of polymeric fibers before the depositing step. In other words, the fibers can bond together where they touch each other to form a stronger non-woven web. The non-woven web can be unconsolidated. The process can further include consolidating the non-woven web. The process can further include consolidating the non-woven web under pressure and temperature.

The process can further include producing a non-woven web comprising the plurality of polymeric fibers. The non-woven web can have a width of up to 1,000 millimeters (mm) or more, for example, 125 mm to 1,000 mm, or 130 to 900 mm, or 150 to 800 mm.

Optionally, the non-woven web can have a width of at least 150 mm.

The process can further include entangling the fibers. The entangling can be at least one of needle-punching and fluid hydro-entanglement.

Optionally, the fibers can be bonded to adjacent fibers or partially bonded to adjacent fibers, e.g., through at least one of a thermal bonding and chemical bonding. For thermal bonding, for example, hot calendering, heated presses, and the like, can be used. For chemical bonding, a binder resin could be used.

Once the fibers have been separated from the polymer dispersion, the remaining mixture can be further processed. For example, the mixture can be treated to separate the solvent and anti-solvent. Possible separation devices include distillation columns, separation membranes, and molecular sieves. Once the streams are separated, they can be recycled accordingly. In order to facilitate the ability to recycle the streams, and in particular the solvent stream, the solvents and anti-solvents can further be chosen so that they are readily separable. For example, the following are combinations of solvents and anti-solvents that can be employed: (i) NMP and water (ii) ethyl alcohol, water, and glycerol. It is noted that the combination of NMP as the solvent and glycerol as the anti-solvent may be effective in producing the fibers, but difficult to separate, and hence less desirable.

The non-woven web can include another material such as polyvinyl pyrrolidine, polymethyl methacrylate, polyvinylidene fluoride, polypropylene, polyethylene oxide, agarose, polyvinylidene fluoride, polylactic glycolic acid, nylon 6, polycaprolactone, polylactic acid, polybutylene terephthalate, and combinations comprising at least one of the foregoing. The amount of the other material can be less than 15 wt %, e.g., less than 10 wt %, specifically, 0.1 to 9 wt %, more specifically, 0.5 to 5 wt %, based upon a total weight of the fibers and the other material. In some embodiments, the process can exclude any detectable amount of polyvinyl pyrrolidine, polymethyl methacrylate, polyvinylidene fluoride, polypropylene, polycarbonate, polyethylene oxide, agarose, polyvinylidene fluoride, polylactic glycolic acid, nylon 6, polycaprolactone, polylactic acid, and polybutylene terephthalate. Wherein detection is based upon currently available detections techniques as of October 2014.

The product, i.e., the fibers, can be used to produce various articles such as wet-laid nonwovens and paper (e.g., electrical insulation paper), medical implants, filters (e.g., ultra-fine filters, oxygenator filters, intravenous (IV) filters, diagnostic test filters, and blood/apheresis filters), membranes, hospital gowns, honeycomb structures and personal hygiene products, and dialyzers. The product can be a composite non-woven product comprising the spun filaments and at least one other fiber. The product can be a composite non-woven product adhered to a rolled sheet product. The product can be a composite non-woven product adhered to at least one of a sheet or film.

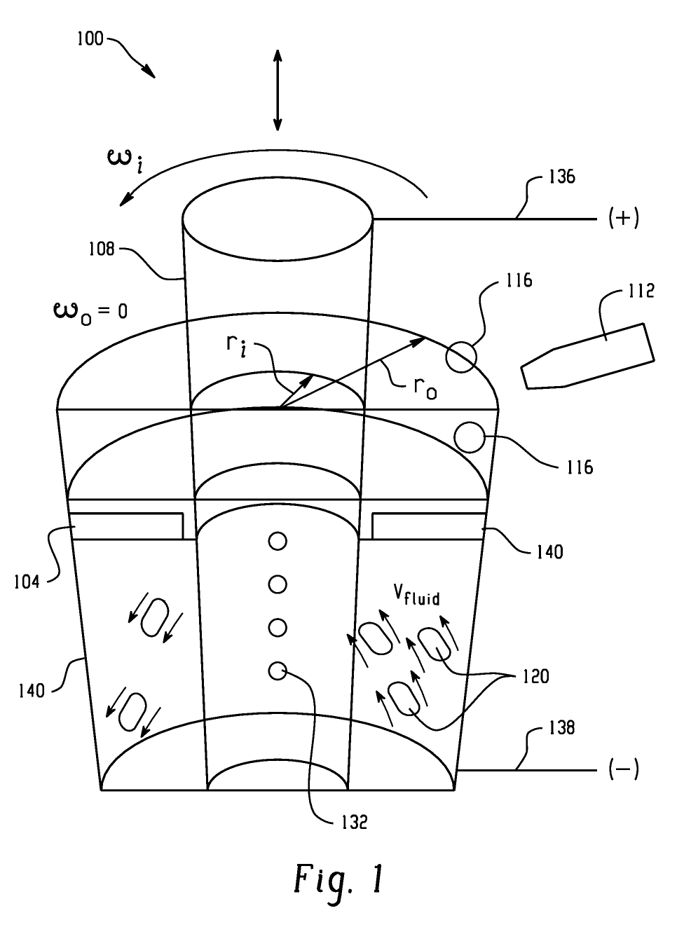

FIG. 1 is a schematic view of an example of a shear spin system 100, as described in US Publication 2013/0012598 to Velev et al. The system 100, which can be utilized for fabricating the fibers, includes a container 104 (e.g., outer cylinder), which can have a heating or cooling jacket positioned around itself, for containing a volume of dispersion medium and receiving the polymer solution, a structure 108 (e.g., inner cylinder) extending out from the container 104, and a dispensing device 112 for supplying the polymer solution to the dispersion medium, which can be heated to provide the required polymer stability temperature. The container 104 and the structure 108 can be concentrically disposed so as to form a volume therebetween for the dispersion medium, with the structure 108 extending through the container 104. Relative motion can be created between the container 104 and the structure 108 to effect shearing. The motion causes the dispersion medium to move at a desired angular velocity, as indicated by an arrow, and imparts a shear stress to the components contained in the outer cylinder. By way of example, FIG. 1 illustrates polymer solution being dispensed into the outer cylinder 104 as droplets 116 and dispersed-phase components 120 of the polymer solution undergoing shear in the dispersion medium, which as described below causes polymer solvent to diffuse out from the dispersed-phase components 120 into the dispersion medium.

The shear stress can be adjusted by changing one or more variables that control the shear stress proportionately, such as the viscosity of the dispersion medium (i.e., the shear medium), the shear rate (e.g., the revolution speed), and the gap size between the outer cylinder and the inner cylinder. By controlling the shear stress, final diameter can be controlled.

In still other implementations, an electrical field may be applied in a radial direction by applying a voltage potential between the outer cylinder 104 and the inner cylinder 108, as depicted schematically by a positive terminal 136 and a negative terminal 138. Alternatively, the apparatus 100 may be configured to apply an electrical field in an axial direction. Depending on the kinetics of the fiber formation, it is possible to permanently polarize electrostatically fibers containing polar side-group chains. Hence, fibers exhibiting anisotropic surface properties may be formed. It is also possible to displace articles inside the polymer creating fibers with anisotropic bulk structure. Other types of fields that can be applied during the shear formation process to modify the properties of the fibers formed include magnetic fields, light fields, or thermal gradients.

In some implementations, one or more baffles may be positioned perpendicular to the cylinders 104, 108, with each baffle having a central opening just large enough for the inner cylinder 104 to pass through, e.g., annular baffle 140. When such a device is filled with a liquid to a level just above the baffle 140, the air is not pulled in and the flow is more stable. One could also make use of additional strategies that have been reported for stabilizing flow.

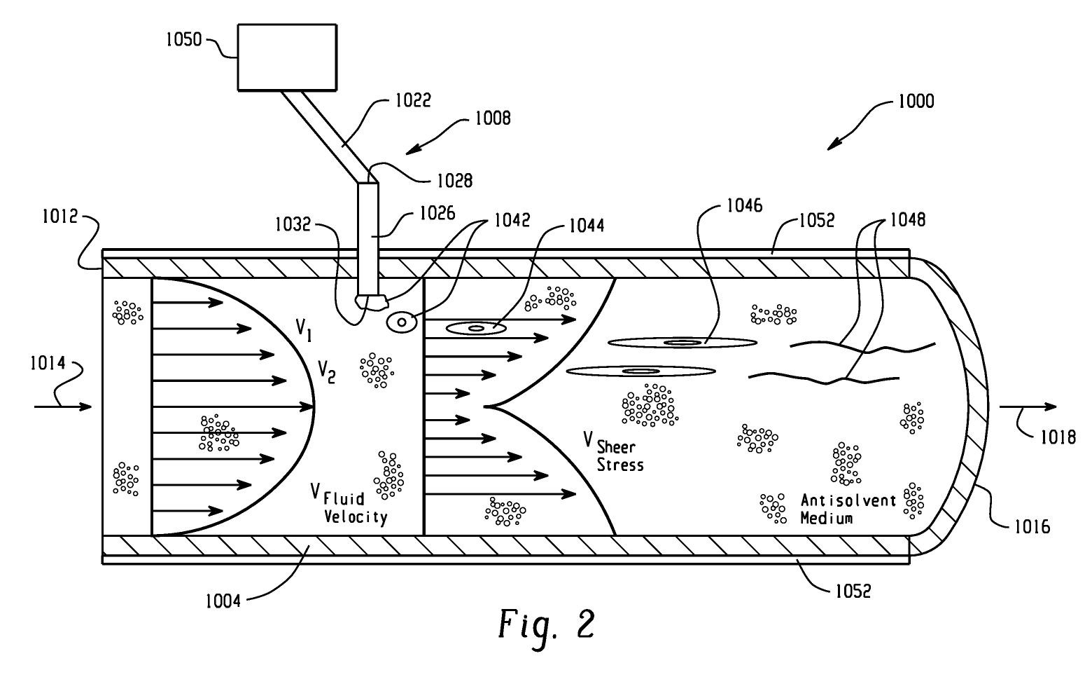

FIG. 2 is a schematic view of an example of continuous shear flow system 1000 that may be utilized for fabricating fibers in a continuous process. The apparatus 1000 generally includes a shear flow conduit 1004 (also referred to as the reaction tube), a fiber precursor solution inlet 1008, and a thermal jacket 1052. The shear flow conduit 1004 includes an inlet 1012 into which the dispersion medium flows as indicated by an arrow 1014, and an outlet 1016 from which fibers carried in the dispersion medium are discharged as indicated by an arrow 1018. The solution inlet 1008 may be any structure suitable for introducing a stream 1022 of fiber precursor solution into the shear flow conduit 1004 and thus into the flowing dispersion medium, such as an opening through the wall of the shear flow conduit 1004 through which conduit(s) (e.g., a second conduit (or side conduit) 1026) can extend. The second conduit 1026 has an inlet 1028 into which a polymer solution flows from a source 1050, and an outlet (or tip) 1032 from which the polymer solution is discharged into the interior of the shear flow conduit 1004. The polymer source 1050 comprises a thermal control to adjust the temperature of the polymer solution. The second conduit 1026 may represent a conduit that is part of a pump or other techniques for flowing the fiber precursor solution into the shear flow conduit 1004.

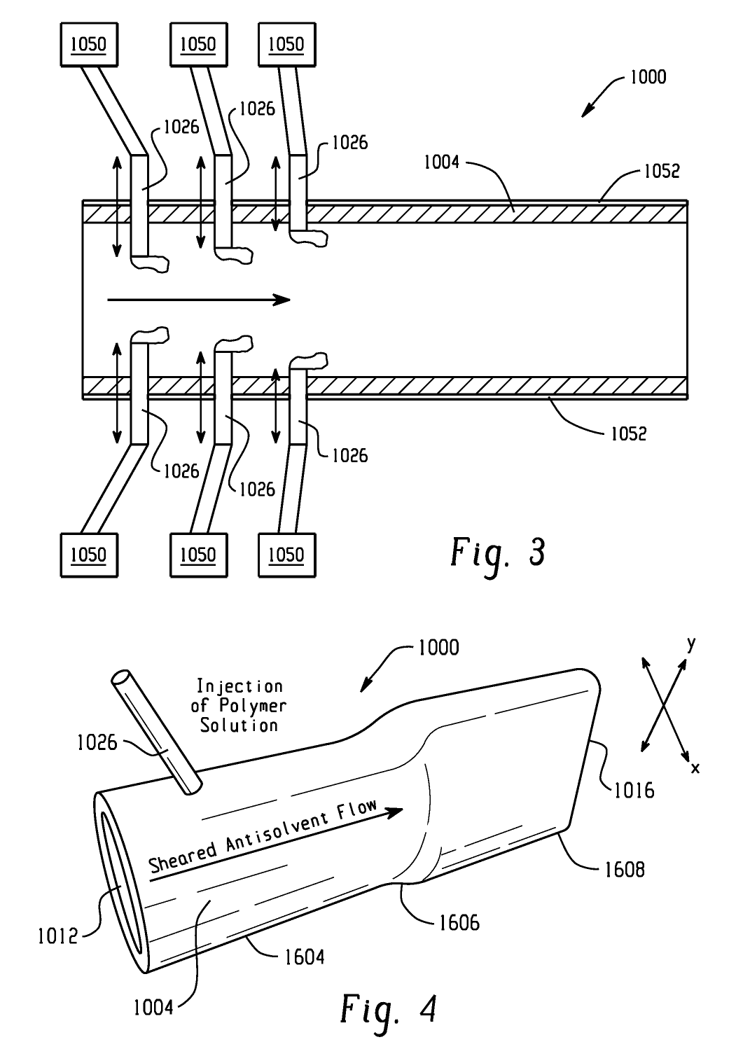

The outlet 1032 can be flush with the opening in the wall of the shear flow conduit 1004, or can extend through the opening such that the outlet 1032 is positioned at some distance in the interior of the shear flow conduit 1004. In the illustrated example the second conduit 1026 is oriented orthogonal to the shear flow conduit 1004, although in other implementations it may generally be oriented at any angle relative to the shear flow conduit 1004. FIG. 3 illustrates the continuous shear flow system 1000 comprising multiple polymer solution conduits (1026). Here they are illustrated as axially spaced from each other along the length of the shear flow conduit 1004 (also known as the reaction tube), enabling multiple injection points and a thermal heating jacket 1052. Optionally, different conduits 1026 can inject the same or different polymer solutions into the dispersion medium. The polymer source 1050 comprises a thermal control to adjust the temperature of the polymer solution. For example, if it is desired to have a mixture of two different types of fibers, some of the conduits can introduce a first polymer solution comprising one of the desired fiber compositions, while other of the conduits can introduce a second (different) polymer solution comprising another of the desired fiber compositions.

In typical implementations, the cross-sectional flow area of the shear flow conduit 1004 (i.e., the interior cross-section of the shear flow conduit 1004 in the plane orthogonal to its central axis) can be polygonal (e.g., rectilinear, trapezoidal, etc.), annular, or elliptical, wherein elliptical includes circular (which is an ellipse having an eccentricity of zero).

The ratio of the length of the shear flow conduit 1004 (i.e., the reaction tube) to the characteristic dimension of its flow area may range from 10 to 600 or greater.

The required reaction tube length is based upon the residence time needed for the polymer to fully fiberize inside the tube. The polymer is fully fiberized when at the shear stress and starting polymer solution viscosity, the application of that sheer stress further elongates the fibers by less than or equal to 5%. Desirably, the fibers are elongated by 0% once fully fiberized.

Such required tube length could be very short, such as 0.2 to 0.5 m for a system with a very short residence time requirement or could be in the range of greater than or equal to 2.5 m, or greater than or equal to 3 m, or greater than or equal to 4 m, and even up to 200 m for a system with a relatively long residence time requirement.

Not to be limited by theory, it is believed that fully fiberizing the fiber in the reaction tube will enhance fiber quality. If the polymer is not fully fiberized it can entangle and stick to other fibers, forming bundles. Due to this, the quality of the fibers generated can be sub-par, with a number of fiber bundles existing in the sample. It is desirable to eliminate fiber bundles, allowing for individual fiber generation. Fully fiberized polymer will have reduced bundling as compared to partially fiberized polymer, and even no bundling. On the other hand, unnecessary tube length other than that required for the polymer to be fully fiberized inside the tube could be avoided once the required residence time is determined. As would be readily understood by an artisan, the required residence time can be readily determined experimentally by adjusting the tube length based upon whether or not the polymer is fully fiberized (e.g., increasing the tube length if the polymer is not fully fiberized).

In operation, a steady or pulsed flow of the dispersion medium is established through the shear flow conduit 1004. For the implementation specifically illustrated in FIG. 2 in which the cross-section of the shear flow conduit 1004 is circular, the steady flow through the shear flow conduit 1004 may be characterized as being Poiseuille flow. The flow through the shear flow conduit 1004 may be characterized by the dimensionless Reynolds number, which may be defined as follows:

$$Re = \frac{ρ {vD}_{H}}{μ} = \frac{{vD}_{H}}{v} = \frac{{QD}_{H}}{uA}$$

where D_{H} is the hydraulic diameter (meters (m)) of the shear flow conduit 1004 (the inside diameter in the case of a circular conduit), Q is the volumetric flow rate (cubic meters per second (m³/s)), A is the cross-sectional area (square meters (m²)) of the shear flow conduit 1004, ν is the mean velocity of the liquid (meters per second (m/s)), μ is the dynamic viscosity of the liquid (Pascal seconds (Pa*s), or kiligram per meter second (kg/(m*s))), ρ is the density of the liquid (kilograms per cubic meter (kg/m³)), and υ=μ/ρ is the kinematic viscosity of the liquid (square meters per second (m²/s)). Generally, the flow of a liquid through a conduit of circular cross-section is considered laminar if its Reynolds number is less than 2,040. In various implementations exemplified herein, the Reynolds number characterizing the flow through the shear flow conduit 1004 may be within the laminar flow regime. Laminar flow is depicted by example in FIG. 2, which schematically illustrates the radial position-dependent profiles of the velocity v and applied shear stress z of the dispersion medium. Velocity is at a minimum at the inside wall of the shear flow conduit 1004 and at a maximum at the central axis, while shear stress is at a maximum at the inside wall and at a minimum at the central axis. In other implementations, the flow through the shear flow conduit 1004 may be generally laminar while exhibiting localized turbulence at one or more locations with the shear flow conduit 1004. In other implementations, the flow may be within the transitional regime between pure laminar flow and pure turbulent flow, or the flow may even be appreciably turbulent.

Optionally, the pump utilized to supply the dispersion medium may be configured to achieve high shear stresses (e.g., greater than 200 Pa). For a given set of fixed dimensions of the shear flow conduit 1004 and viscosity of the selected dispersion medium, other flow parameters may be set or adjusted as needed for a particular production run. For example, the volumetric flow rate of the dispersion medium through the shear flow conduit 1004 may range from a few milliliters per second (mL/sec) to tens of liters per minute (L/min) or greater. In another example, the flow rate may range from 30 mL/sec to greater. In another example, the flow rate may range from 35-75 L/min. In one non-limiting example, the pressure of the dispersion medium at the inlet 1012 of the shear flow conduit 1004 may be 0 to 125 pounds per square inch gauge (psig) or higher.

Once the flow of the dispersion medium is established, the polymer solution is injected as a continuous stream into the flowing dispersion medium via the second conduit 1026 or other type of solution inlet 1008. For example, the polymer solution can be injected under pressure, such as with a gear pump. As one non-limiting example, the volumetric flow rate of the polymer solution as it is introduced into the shear flow conduit 1004 may range from a few mL/min to several L/min or greater. For example, the flow rate may be greater than or equal to 5 mL/min, e.g., 1 to 5 L/min or higher. The pressure of the polymer solution at the solution inlet 1008 may be 0 to 125 psig or higher.

FIG. 2 schematically depicts a dispersed-phase component 1042 of the fiber precursor solution near the outlet 1032 of the second conduit 1026. The fiber precursor solution may be injected into the dispersion medium already in the form of a plurality of polymer components 1042, or as a continuous phase that breaks up into polymer components 1042 upon mixing with the dispersion medium. FIG. 2 also schematically depicts a polymer component deforming under shear at 1044, and breaking up into smaller polymer components 1046, which elongate and stiffen into insoluble fibers 1048.

The polymer solution can be flowed into the dispersion medium on a continuous basis, or in intervals (e.g., pulses of a desired duration). The flow rate of the dispersion medium and/or the flow rate (injection rate) of the polymer solution may be constant (or substantially constant), or may be varied according to a desired profile (e.g., a ramped, sinusoidal, saw-tooth, square-wave, or stepped flow rate). In some implementations, a variable speed injection of the polymer solution may be performed to intentionally produce a wide variation in fiber diameters, which may be desirable in certain applications. Higher flow rates (or shear rates) of the dispersion medium, or lower injection rates of the polymer solution, can result in fibers of smaller diameters. Optionally, the polymer solution may be injected in the form of pre-made droplet dispersion into an appropriate intermediate medium that is miscible with the shear medium.

The final diameter can be controlled, and the polydispersity of the fibers can be reduced if desired, by controlling (or adjusting) the applied shear stress. In the continuous process, shear stress may be controlled in a number of ways, such as by modifying the flow rate and/or viscosity of the dispersion medium. The viscosity of the dispersion medium may be modified in real time by, for example, changing its temperature, the addition of additives (such as viscosity modifiers) or switching to a dispersion medium having a different composition. Shear stress may also be controlled by replacing the shear flow conduit 1004 for another conduit having a different geometry. The temperature of the polymer solution can also be adjusted.

The continuous process can similarly be varied or modified. For example, the continuous process may be employed to produce composite fibers by incorporation of selected particles in the fiber precursor solution. As another example, the continuous process may be employed to produce composite fibers by incorporation of a selected inorganic precursor material in the fiber precursor solution. As in the case of the batch processes, upon shear-induced filament elongation of the dispersed-phase components (consisting of the mixture of polymer solution and inorganic precursor), as the polymer solvent diffuses out from the as-forming fibers, phase separation occurs between the polymer and the inorganic precursor, leading to the formation of insoluble composite fibers. Also as in the batch case, if desired, pure inorganic fibrils may be released from the composite fibers by performing an appropriate polymer removal technique as described above (e.g., calcination, chemical treatment, thermal oxidation, dissolution, enzymatic degradation, etc.). Examples of various additives and inorganic precursors are described earlier in this disclosure.

As the fibers are fabricated they may be transported from the outlet 1016 of the shear flow conduit 1004 to any suitable destination and subjected to any suitable post-fabrication processing steps.

As noted above, the second conduit 1026 associated with the solution inlet 1008 may extend into the shear flow conduit 1004 such that the outlet 1032 of the second conduit 1026 is positioned at a desired radial distance from the central axis of the shear flow conduit 1004. The position of the outlet 1032 of the second conduit 1026 may be selected so as to optimize fiber production in view of a given set of other operating parameters (e.g., compositions of the polymer solution and dispersion medium, shear flow rate, injection rate, viscosity, shear stress to be applied, etc.). Optionally, the second conduit(s) 1026 can be movable relative to the shear flow conduit 1004, as indicated by the arrows (see FIG. 3). That is, the position of the outlet 1032 of the second conduit 1026 relative to the central axis of the shear flow conduit 1004 is adjustable.

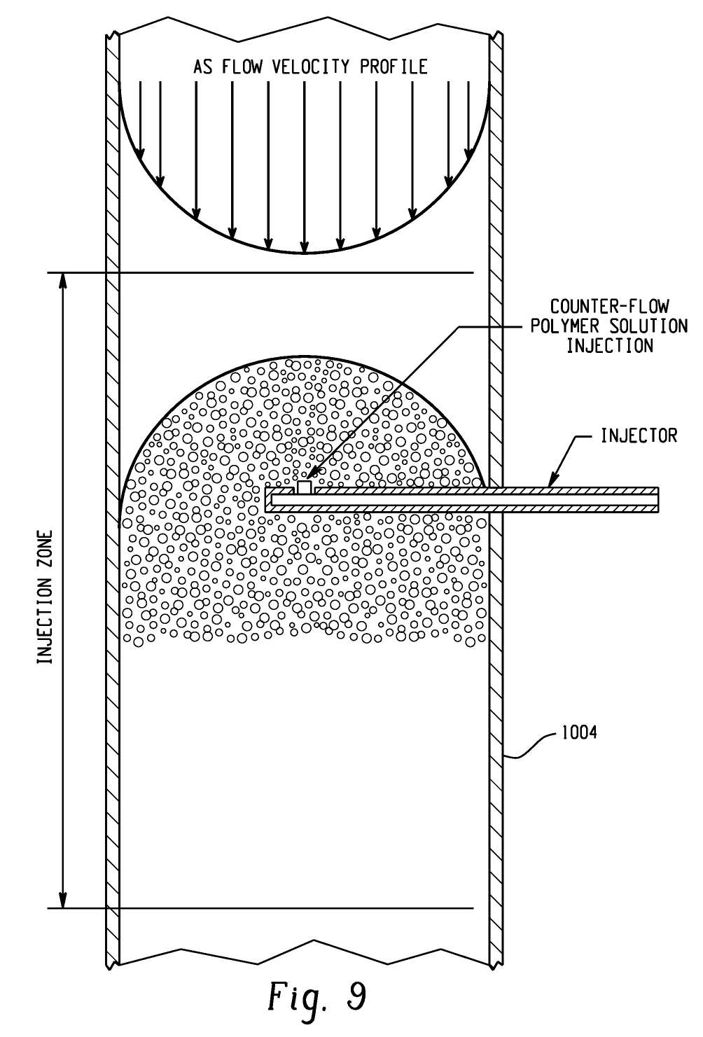

In FIGS. 2 and 3, the outlet 1032 of the second conduit 1026 is oriented such that the polymer solution is injected in a direction orthogonal to the direction of the flow of dispersion medium, i.e., in a cross-flow direction. Optionally, polymer solution is injected in the same direction as the flow of dispersion medium, i.e., in a co-flow direction. As is illustrated in FIG. 9, alternatively the polymer solution can be injected in the direction opposing the flow of dispersion medium, i.e., in a counterflow direction, such that dispersed-phase components of the polymer solution are sheared away from the injection point. As is further illustrated in FIG. 9, the injection point can optionally be at the center of the reaction tube 1004. Optionally, the injection point can be near the center of the reaction tube, e.g., injection point is 90% to 100% of the radius of the reaction tube from the wall. The injection point can be between the wall and the center of the reaction tube.

In some implementations, the geometry of the shear flow conduit 1004 may be altered at one or more points along its length (typically downstream from the injection point(s)) to improve one or more process parameters. For example, the initial geometry of the shear flow conduit 1004 may be transitioned to a more constricted geometry in which the cross-sectional flow area of the shear flow conduit 1004 is reduced in one or both dimensions. Depending on how the modification in geometry is implemented, it may result in higher and/or more uniform shear stress being applied to the fiber precursor solution, and in turn may result in fibers of smaller and/or more uniform diameter.

In FIG. 4, the shear flow conduit 1004 is configured such that one of the dimensions of its cross-sectional flow area changes relative to the other dimension downstream of the polymer solution injection area. In the example specifically illustrated, the shear flow conduit 1004 includes a first section 1604 having an elliptical (circular in the illustrated example) cross-sectional flow area, followed by a transitional section 1606, followed by a second section 1608 having a slot-shaped cross-sectional flow area. Defining the cross-sectional flow area by x- and y-axes, the transition to the slot-shaped second section 1608 is characterized by a significant reduction in the x-dimension.

Alternative implementations may be provided for increasing shear stress while the fibers are forming. As one example, the fiber precursor solution may be flowed through a gap between concentric cones. At least one cone may be rotated relative to the other cone in a manner analogous to a colloidal mill. As another example, the fiber precursor solution may be flowed through a homogenizing device that includes a ball spring or other type of high-pressure or high-shear valve.

As one non-limiting example of the continuous process, a high-pressure continuous shear flow device was configured similar to that illustrated in FIG. 2. The shear flow conduit was a heated stainless steel tube with a straight length and circular cross-section, having a length of four feet and an inside diameter of 4 mm, and having a thermal jacket. A pump was placed in communication with the inlet of the shear flow conduit to supply the viscous dispersion medium.

Pumps that have been used include triplex positive displacement pump (CAT Pumps, Minneapolis, Minn., Model #2SF20ES), and diaphragm pumps (e.g., stainless air diaphragm pumps). Optionally, the dispersion medium can be heated (e.g., heated in a flask and then pumped while warm). An inlet was formed through the wall of the shear flow conduit. A pump was placed in communication with the small inlet to pump the polymer solution. Pumps that have been used include syringe pump (New Era Pump Systems Inc., Farmingdale, N.Y., Model # NE-1000) and a gear pump.

The invention is further described in the following illustrative examples in which all parts and percentages are by weight unless otherwise indicated.

### EXAMPLES

### Example 1

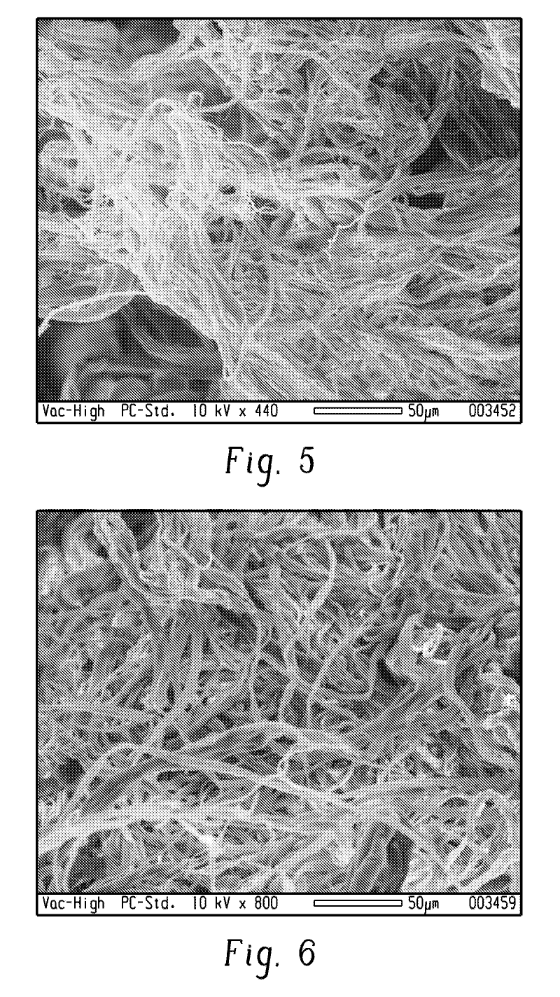

A solution of 22 wt % polyetherimide (ULTEM™ CRS5001K) dissolved in n-methylpyrrolidone (NMP) was injected into a flowing dispersion medium stream comprising 94.5 wt % NMP and 5.5 wt % water, which had a viscosity of about 2 cP. The polymer solution was maintained in a holding tank at a temperature of 160° C. until it is injected at a flow rate of 100 ml/min into the dispersion medium which was heated to 55° C., and which was flowing past the injection point at a flow rate of 4 gallons per minute (gal/min). The dispersion medium was flowing in a reaction tube with a diameter of 9.53 mm and a length of 1 m. The injection point was located at the beginning of the reaction tube and had a diameter of 0.8 mm. After the polymer solution injection, fibers were formed and then collected, the resulting fibers had diameters between 1-25 μm. FIG. 5 illustrates the fibers formed.

### Example 2

A solution of 22 wt % polyetherimide (ULTEM™ CRS5001K) dissolved in n-methylpyrrolidone (NMP) was injected into a flowing dispersion medium stream comprising 94.5 wt % NMP and 5.5 wt % water, which had a viscosity of about 2 cP. The polymer solution was maintained in a holding tank at a temperature of 160° C. until it was injected at a flow rate of 20 ml/min into the dispersion medium which was heated to 60° C., and which was flowing past the injection point at a flow rate of 4 gal/min. The dispersion medium was flowing in a reaction tube with a diameter of 4.57 mm and a length of 1 m. The injection point was located at the beginning of the reaction tube and had a diameter of 0.8 mm. After the polymer solution injection, fibers are formed and then collected, the resulting fibers had diameters between 1-25 μm. FIG. 6 illustrates the fibers formed.

### Example 3

A solution comprised of 22 wt % (ULTEM™ CRS5001K) dissolved in n-methylpyrrolidone (NMP) was injected into a flowing dispersion medium stream of 95.5 wt % NMP and 4.5 wt % water, which had a viscosity of about 2 cP. The polymer solution was maintained in a holding tank at a temperature of 180° C. until it was injected at a flow rate of 100 ml/min into the dispersion medium which was heated to 20° C., and which was flowing past the injection point at a flow rate of 4 gal/min. The dispersion medium was flowing in a reaction tube with a diameter of 9.53 mm and a length of 1 m. The injection point was located at the beginning of the reaction tube and had a diameter of 6 mm. Upon polymer solution injection, fibers were not formed.

### Example 4

A solution of 22 wt % (ULTEM™ CRS5011K) dissolved in n-methylpyrrolidone (NMP) was injected into a flowing dispersion medium stream of 94.5 wt % NMP and 5.5 wt % water, which had a viscosity of about 2 cP. The polymer solution was maintained in a holding tank at a temperature of 125° C. until it was injected at a flow rate of 100 ml/min into the dispersion medium which was heated to 20° C., and which was flowing past the injection point at a flow rate of 4 gal/min. The dispersion medium was flowing in a reaction tube with a diameter of 9.53 mm and a length of 1 m. The injection point was located at the beginning of the reaction tube and had a diameter of 6 mm. Upon polymer solution injection, fibers were not formed.

### Example 5

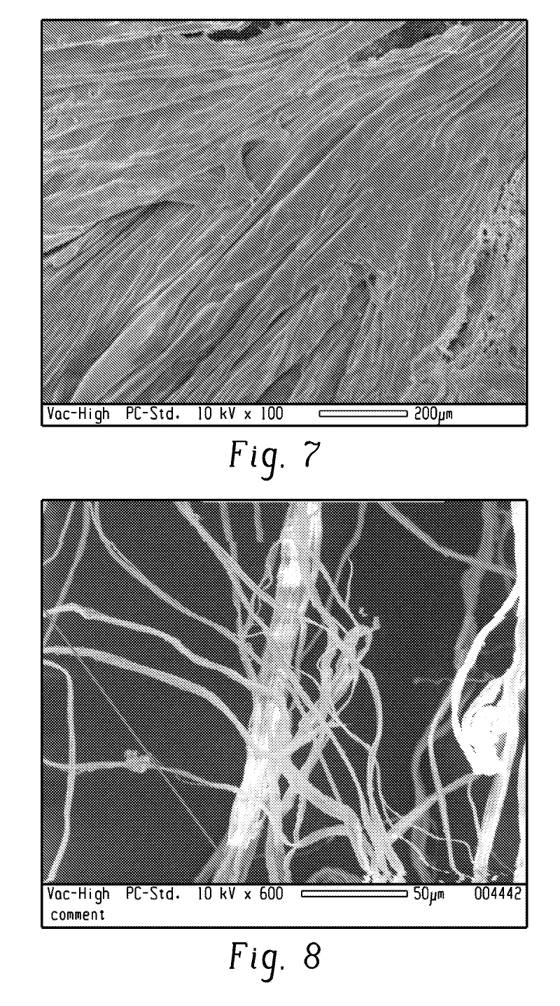

A solution of 12 wt % (ULTEM™ CRS5011K) dissolved in n-methylpyrrolidone (NMP) was injected into a flowing dispersion medium stream of 30 wt % NMP, 49 wt % glycerol, 14 wt % ethyl alcohol, and 7 wt % water. The polymer solution was maintained at room temperature (25° C.) until it was injected into the dispersion medium which was also at room temperature. Upon polymer solution injection, fibers were not formed. FIG. 7 illustrates the sample morphology.

### Example 6

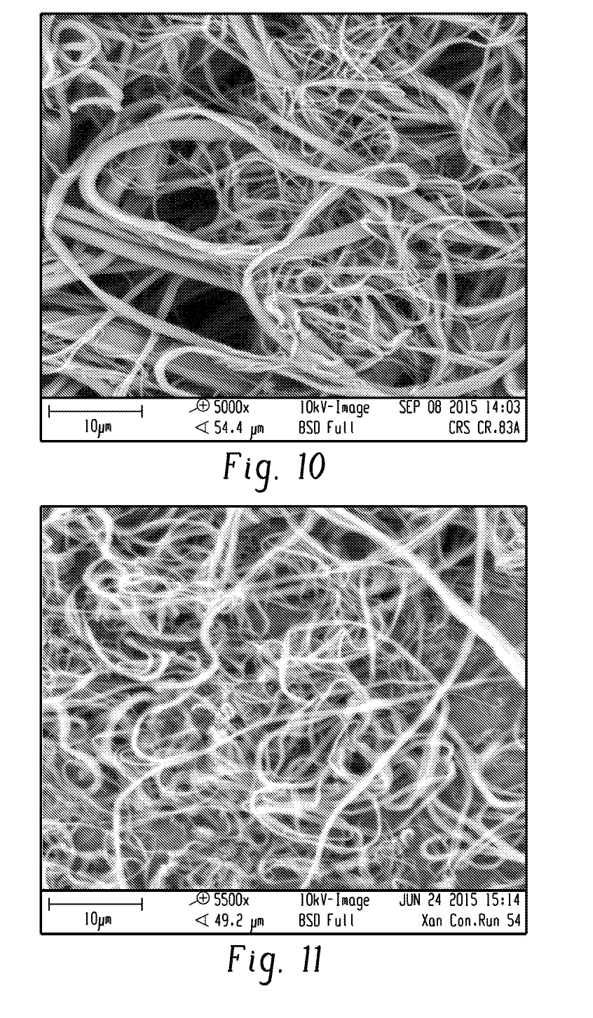

A solution of 28 wt % (ULTEM™ CRS5001K) dissolved in n-methylpyrrolidone (NMP) was injected into a flowing dispersion medium stream of 7.7 wt % water, 12.5 wt %, polyvinylpyrrolidone (PVP) grade K-30 and 79.8 wt % NMP, which had a viscosity of about 25 cP at 25° C. The polymer solution was maintained in a holding tank at a temperature of 180° C. until it was injected at a flow rate of 20 g/min into the dispersion medium which was heated to 50° C., and which was flowing past the injection point at a flow rate of 4.5 gal/min. The dispersion medium was flowing in a reaction tube with a diameter of 9.53 mm and a length of 2.5 m. The injection point was located at the beginning of the reaction tube and had a diameter of 1.194 mm. After the polymer solution injection, fibers are formed and then collected; the resulting fibers had an average diameter of 1.15 m and a standard deviation of 400 nm. FIG. 10 illustrates the fibers formed.

### Example 7

A solution of 22 wt % (ULTEM™ CRS5001K) dissolved in n-methylpyrrolidone (NMP) was injected into a flowing dispersion medium stream of 7.4 wt % water, 12.5 wt % polyvinylpyrrolidone (PVP) grade K-30 and 80.1 wt % NMP, which has a viscosity of about 25 cP at 25° C. The polymer solution was maintained in a holding tank at a temperature of 180° C. until it was injected at a flow rate of 20 g/min into the dispersion medium which was heated to 45° C., and which was flowing past the injection point at a flow rate of 4.5 gal/min. The dispersion medium was flowing in a reaction tube with a diameter of 9.53 mm and a length of 2.5 m. The injection point was located at the beginning of the reaction tube and had a diameter of 1.194 mm. After the polymer solution injection, fibers are formed and then collected; the resulting fibers had an average diameter of 930 nm and a standard deviation of 329 nm. FIG. 11 illustrates the fibers formed.

### Example 8

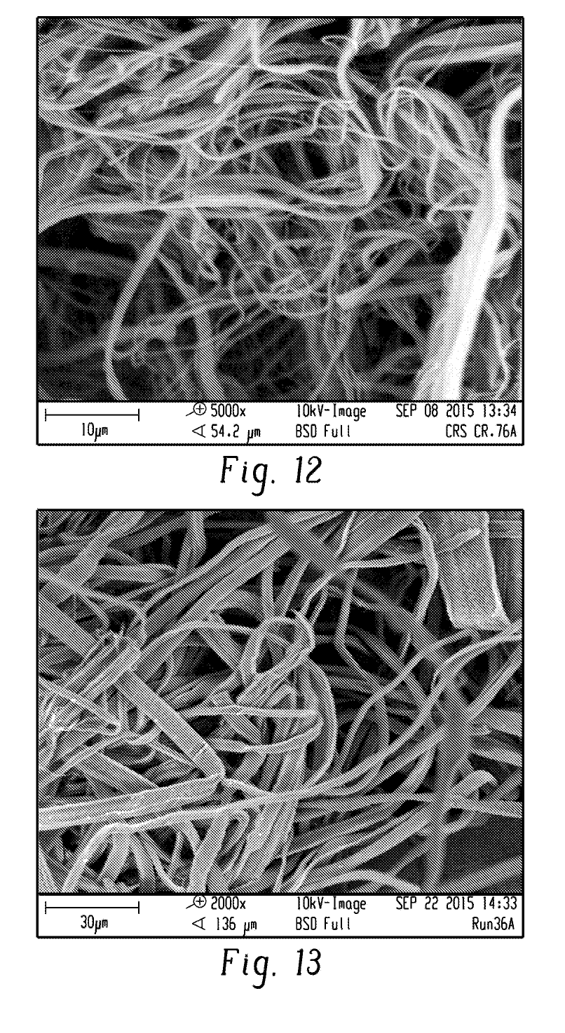

A solution of 26 wt % (ULTEM™ CRS5001K) dissolved in n-methylpyrrolidone (NMP) was injected into a flowing dispersion medium stream of 7.7 wt % water, 12.5 wt % polyvinylpyrrolidone (PVP) grade K-30 and 79.8 wt % NMP, which has a viscosity of about 25 cP at 25° C. The polymer solution was maintained in a holding tank at a temperature of 180° C. until it was injected at a flow rate of 20 g/min into the dispersion medium which was heated to 50° C., and which was flowing past the injection point at a flow rate of 4.5 gal/min. The dispersion medium was flowing in a reaction tube with a diameter of 9.53 mm and a length of 2.5 m. The injection point was located at the beginning of the reaction tube and had a diameter of 1.194 mm. After the polymer solution injection, fibers are formed and then collected; the resulting fibers had an average diameter of 1.11 m and a standard deviation of 405 nm. FIG. 12 illustrates the fibers formed.

### Example 9

A solution of 18 wt % (ULTEM™ CRS5001K) dissolved in n-methylpyrrolidone (NMP) was injected into a flowing dispersion medium stream of 8.2 wt % water, 3.5 wt % polyvinylpyrrolidone (PVP) grade K-90 and 88.3 wt % NMP, which has a viscosity of about 60 cP at 25° C. The polymer solution was maintained in a holding tank at a temperature of 180° C. until it was injected at a flow rate of 20 g/min into the dispersion medium which was heated to 40° C., and which was flowing past the injection point at a flow rate of 4.5 gal/min. The dispersion medium was flowing in a reaction tube with a diameter of 9.53 mm and a length of 2.5 m. The injection point was located at the beginning of the reaction tube and had a diameter of 1.194 mm. After the polymer solution injection, fibers are formed and then collected; the resulting fibers had an average diameter of 3.0 m and a standard deviation of 1.2 m. FIG. 13 illustrates the fibers formed.

As is described above, the present process can be used to form unique fibers. The process enables the production of non-continuous fibers from polymers that are chemically unstable when in solution at room temperature (solubility of less than 10 g/L at 25° C.; in other words, elevated temperatures (greater than 30° C.) would be needed to maintain the polymer in solution). For example, fibers produced from this process, are not continuous, which is beneficial for wet laid nonwovens. Previously, chemically resistant PEI fibers were produced in a continuous filament. Stable non-continuous fibers could not be directly produced (e.g., without cutting). Hence, the present process is capable of directly producing non-continuous fibers from the materials that are chemically unstable in solution at room temperature (e.g., 25° C.). Although further processing (e.g., cutting) can be performed to further change the size of the fibers and/or to obtain a desired size distribution, cutting is not needed to produce the non-woven fibers.

Set forth below are some embodiments of the method and fibers disclosed herein.

### Embodiment 1

A method of making fibers, comprising: flowing a dispersion medium through a reaction tube, wherein the dispersion medium comprises an anti-solvent; adjusting a temperature of a polymer solution to form a stable polymer solution, wherein the polymer solution comprises a polymer (also referred to as the first polymer) and a solvent; introducing the stable polymer solution into the dispersion medium to form a polymer dispersion wherein the stable polymer solution comprises a first polymer and a solvent; and shearing the dispersed-phase components by flowing the dispersion system through the reaction tube, wherein a plurality of fibers having an average diameter of less than or equal to 10 m are formed.

### Embodiment 2

The method of Embodiment 1, further comprising adjusting the temperature of the dispersion medium.

### Embodiment 3

The method of any of the preceding Embodiments, wherein the temperature of the dispersion medium is adjusted to greater than or equal to (>) 30° C., preferably adjusted to >40° C., or preferably adjusted to >50° C., or preferably adjusted to <20° C.

### Embodiment 4

The method of any of the preceding Embodiments, wherein the temperature of the polymer solution is adjusted to >20° C., preferably adjusted to >30° C., or preferably adjusted to >80° C., or preferably adjusted to >100° C., or preferably adjusted to >150° C.

### Embodiment 5

The method of any of the preceding Embodiments, wherein the anti-solvent comprises at least one of water, methanol, acetone, toluene, ethyl alcohol, propyl glycol, propylene glycol, and glycerin, preferably the antisolvent comprises water.

### Embodiment 6

The method of any of the preceding Embodiments, wherein the polymer comprises a polyetherimide having a Tg of greater than or equal to 220° C. and having a Mw of greater than 40,000 Daltons, as determined using GPC using polystyrene standards (preferably, the Mw of >60,000 Daltons); and the solvent comprises NMP, wherein dispersion medium comprises 2 wt % to 10 wt % water and 90 wt % to 98 wt % NMP.

### Embodiment 7

The method of any of the preceding Embodiments, wherein the polymer has a solubility of less than to 10 g/L in the solvent at room temperature, preferably a solubility of less than or equal to 5 g/L in the solvent at room temperature, or preferably a solubility of less than or equal to 2 g/L in the solvent at room temperature (e.g., 25° C.). Preferably the polymer has a solubility of greater than 15 g/L in the solvent at a temperature of >30° C., preferably a temperature of >40° C.

### Embodiment 8

The method of any of the preceding Embodiments, wherein the dispersion medium has a dispersion medium viscosity, and further comprising increasing the dispersion medium viscosity, wherein the dispersion medium viscosity is increased using at least one of the foregoing: adding particles; dissolving a salt in the dispersion medium; reducing the temperature of the dispersion medium; dissolving sodium alginate in the dispersion medium; and dissolving a second polymer in the dispersion medium.

### Embodiment 9

A method of making fibers, comprising: increasing a dispersion medium viscosity of a dispersion medium, wherein the dispersion medium comprises an anti-solvent, and wherein the dispersion medium viscosity is increased using at least one of the foregoing: adding particles to the dispersion medium; dissolving a salt in the dispersion medium; reducing the temperature of the dispersion medium; dissolving sodium alginate in the dispersion medium; and dissolving a second polymer in the dispersion medium; flowing a dispersion medium through a reaction tube; introducing a stable polymer solution into the dispersion medium to form a polymer dispersion comprising the dispersion medium and a plurality of polymer components of the polymer solution; and shearing the dispersed-phase components by flowing the dispersion system through the reaction tube, wherein a plurality of fibers having an average diameter of <10 m are formed.

### Embodiment 10

The method of any of Embodiments 8-9, wherein increasing the dispersion medium viscosity comprises adding particles to the dispersion medium, wherein the particles comprise particles having a diameter of less than 1 Gm, preferably, the particles having an average diameter of less than or equal to 100 nm.

### Embodiment 11

The method of any of Embodiments 8-10, wherein increasing the dispersion medium viscosity comprises dissolving the salt in the dispersion medium, wherein the salt comprises lithium chloride salt, lithium bromide, or a combination comprising at least one of the foregoing.

### Embodiment 12

The method of any of Embodiments 8-11, wherein increasing the dispersion medium viscosity comprises dissolving sodium alginate in the dispersion medium.

### Embodiment 13

The method of any of Embodiments 8-12, wherein increasing the dispersion medium viscosity comprises dissolving the second polymer in the dispersion medium, wherein the second polymer comprises polyvinylpyrrolidone (PVP), polyethylene glycol (PEG), polyvinyl alcohol (PVA), and combinations comprising at least one of the foregoing; preferably the polymer comprises PVP.

### Embodiment 14

The method of any of the preceding Embodiments, wherein dissolving the second polymer into the dispersion medium further comprises forming a second polymer solution and introducing the second polymer solution to the dispersion medium, wherein the second polymer is a different material than the first polymer.

### Embodiment 15

The method of any of the preceding Embodiments, wherein the first polymer comprises PEN, PEI, PPE, polyamic acid, PEEK, or a combination comprising at least one of the foregoing.

### Embodiment 16

The method of any of the preceding Embodiments, wherein the shearing is continued until the first polymer is fully fiberized.

### Embodiment 17

The method of any of the preceding Embodiments, wherein the introducing the polymer solution comprises injecting the polymer solution into a reaction tube comprising a flow of the dispersion medium, and wherein the injecting is at 90% to 100% of a radius of the reaction tube from a tube wall, preferably wherein the injecting is at the center of the reaction tube.

### Embodiment 18

The method of Embodiment 17, further comprising injecting the polymer solution in a direction counter current to a flow direction of the dispersion medium.

### Embodiment 19

The method of any of the preceding Embodiments, further comprising dissolving a third polymer in the dispersion medium, wherein the dissolved polymer affects the viscosity of the dispersion medium. The third polymer can be a different material than the first polymer and the second polymer. The third polymer can be at least one of polyvinylpyrrolidone (PVP), polyethylene glycol (PEG), and polyvinyl alcohol (PVA), preferably the third polymer is PVP. The third polymer can be the same material as the second polymer, but with a different Mw.

### Embodiment 20

The method of Embodiment 19, wherein the third polymer has a Mw of 4,000 to 3,000,000 g/mol, preferably 40,000 to 1,700,000 g/mol, and or preferably 40,000-80,000 g/mol, as measured with SEC (Size exclusion chromatography) using a ultrahydrogel linear column by Waters Laboratory Analytics. The eluent used is an 80/20 mix of 0.1 M (molar) sodium nitrate to acetonitrile, based upon a polyacrylate standard for Mw up to 1,000,000. The number can be further resolved using low-angle laser light scattering (LALLS).

### Embodiment 21

The method of any of Embodiments 19-20, wherein the third polymer comprises at least one of PVP, PEG, and PVA, preferably the third polymer is PVP, more preferably, wherein the third polymer is PVP.

### Embodiment 22

The method of Embodiment 21, wherein the third polymer is at least one of having a Mw of 1,000,000-1,700,000 g/mol, 390,000-470,000 g/mol, and 40,000-80,000 g/mol, preferably the third polymer has a Mw of 1,000,000-1,700,000 g/mol, or preferably the third polymer has a Mw of 40,000-80,000 g/mol. The Mw was measured with SEC (Size exclusion chromatography) using a ultrahydrogel linear column by Waters Laboratory Analytics. The eluent used is an 80/20 mix of 0.1 M (molar) sodium nitrate to acetonitrile, based upon a polyacrylate standard for Mw up to 1,000,000. The number can be further resolved using low-angle laser light scattering (LALLS).

### Embodiment 23

The method of any of the preceding Embodiments, wherein the dispersion medium further comprises a carrier, and wherein the carrier is at least one of glycerin, cresol, tetrachloroethane, HFIP, meta-cresol, veratrol, ODCB, NMP, chloroform, THF, DMF, DCM, NEP, NVP, 2-Py, DMI, DMAc, DMSO, DPGME, and preferably the carrier is at least one of glycerin, ODCB, THF, DCM, meta-cresol, veratol, DEC, NMP, and DCM.

### Embodiment 24

The method of any of the preceding Embodiments, wherein the first polymer is a polymer (e.g., a material) that is chemically unstable when in solution at room temperature.

### Embodiment 25

The method of any of the preceding Embodiments, wherein the first polymer is polyetherimide.

### Embodiment 26

The method of any of the preceding Embodiments, wherein the solvent comprises at least one of NMP, NEP, NVP, 2-Py, DMI, DMF, DMAc, DMSO, DPGME, and NMP, preferably the solvent comprises NMP.

### Embodiment 27

The method of any of the preceding Embodiments, wherein the fibers are non-continuous as they exit the reaction tube

### Embodiment 28

A plurality of fibers formed by the method of any of the preceding Embodiments.

### Embodiment 29

The fibers of Embodiment 28, wherein the fibers have an average diameter of less than 1 μm, preferably an average diameter of 200 nm to 900 nm, or preferably 300 nm to 700 nm.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. As used herein, the dispersion medium comprises an anti-solvent, and optionally comprises a carrier and further optionally comprises a viscosity modifier.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All cited patents, patent applications, and other references are incorporated herein by reference in their entirety. However, if a term in the present application contradicts or conflicts with a term in the incorporated reference, the term from the present application takes precedence over the conflicting term from the incorporated reference. For example, U.S. Publication No. 2013/0012598A1 is incorporated herein by reference in its entirety.

I/We claim:

1. A method of making fibers, comprising:
flowing a dispersion medium through a reaction tube, wherein the dispersion medium comprises an anti-solvent;
adjusting a temperature of a polymer solution to form a stable polymer solution, wherein the polymer solution comprises a first polymer and a solvent;
introducing the stable polymer solution into the dispersion medium to form a polymer dispersion comprising the dispersion medium and a plurality of polymer components of the polymer solution; and
shearing the dispersed-phase components by flowing the dispersion system through the reaction tube, wherein a plurality of fibers having an average diameter of less than or equal to 10 m are formed.

2. The method of claim 1, wherein the dispersion medium has a dispersion medium viscosity, and further comprising increasing the dispersion medium viscosity, wherein the dispersion medium viscosity is increased using at least one of the foregoing: adding particles; dissolving a salt in the dispersion medium; reducing the temperature of the dispersion medium; dissolving sodium alginate in the dispersion medium; and dissolving a second polymer in the dispersion medium.

3. A method of making fibers, comprising:
increasing a dispersion medium viscosity of a dispersion medium, wherein the dispersion medium comprises an anti-solvent, and wherein the dispersion medium viscosity is increased using at least one of the foregoing:
adding particles to the dispersion medium; dissolving a salt in the dispersion medium; reducing the temperature of the dispersion medium;
dissolving sodium alginate in the dispersion medium; and dissolving a second polymer in the dispersion medium;
flowing the dispersion medium through a reaction tube;
introducing a stable polymer solution into the dispersion medium to form a polymer dispersion, wherein the stable polymer solution comprises a first polymer and a solvent; and
shearing the dispersed-phase components by flowing the dispersion system through the reaction tube, wherein a plurality of fibers having an average diameter of less than or equal to 10 m are formed.

4. The method of claim 3, wherein increasing the dispersion medium viscosity comprises adding particles to the dispersion medium, wherein the particles comprise particles having a diameter of less than 1 μm.

5. The method of claim 3, further comprising adjusting the temperature of the dispersion medium, wherein the temperature of the dispersion medium is adjusted to greater than or equal to 30° C.

6. The method of claim 3, wherein the temperature of the polymer solution is adjusted to less than or equal to 20° C.

7. The method of claim 3, wherein the first polymer comprises polyetherimide,
wherein the anti-solvent comprises at least one of water, methanol, acetone, toluene, ethyl alcohol, propyl glycol, propylene glycol, and glycerin;
wherein the solvent comprises at least one of NMP, NEP, NVP, 2-Py, DMI, DMF, DMAc, DMSO, DPGME, and NMP.

8. The method of claim 3, wherein the first polymer comprises a polyetherimide having a Tg of greater than or equal to 220° C. and having a Mw of greater than 40,000 Daltons as determined using GPC using polystyrene standards; and the solvent comprises NMP, wherein dispersion medium comprises 2 wt % to 10 wt % water and 90 wt % to 98 wt % NMP.

9. The method of claim 3, wherein the first polymer has a solubility of less than to 10 g/L in the solvent at room temperature.

10. The method of claim 3, further comprising introducing a second polymer solution to the dispersion medium, wherein the second polymer solution comprises a second polymer that is a different material than the polymer in the polymer solution.

11. The method of claim 3, wherein the first polymer comprises PEN, PEI, PPE, polyamic acid, PEEK, or a combination comprising at least one of the foregoing.

12. The method of claim 3, wherein the shearing is continued until the first polymer is fully fiberized.

13. The method of claim 3, wherein the introducing the polymer solution comprises injecting the polymer solution into the reaction tube comprising a flow of the dispersion medium, and wherein the injecting is at 90% to 100% of a radius of the reaction tube from a tube wall.

14. The method of claim 13, further comprising injecting the polymer solution in a direction counter current to a flow direction of the dispersion medium.

15. The method of claim 13, further comprising dissolving a third polymer in the dispersion medium, wherein the third polymer affects the viscosity of the dispersion medium.

16. The method of claim 15, wherein the third polymer has
a Mw of 4,000 to 3,000,000 g/mol, as measured with SEC (Size exclusion chromatography) using a ultrahydrogel linear column by Waters Laboratory Analytics. The eluent used is an 80/20 mix of 0.1 M (molar) sodium nitrate to acetonitrile, based upon a polyacrylate standard for Mw up to 1,000,000; or
a Mw of 1,000,000-1,700,000 g/mol as measured with SEC (Size exclusion chromatography) using an ultrahydrogel linear column by Waters Laboratory Analytics. The eluent used is an 80/20 mix of 0.1 M (molar) sodium nitrate to acetonitrile, based upon a polyacrylate standard for Mw up to 1,000,000. The number can be further resolved using low-angle laser light scattering (LALLS).

17. The method of claim 15, wherein the third polymer is at least one of polyvinylpyrrolidone, polyethylene glycol, and polyvinyl alcohol.

18. The method of claim 17, wherein the third polymer has at least one of a Mw of 1,000,000-1,700,000 g/mol, a Mw of 390,000-470,000 g/mol, and a Mw of 40,000-80,000 g/mol as measured with SEC (Size exclusion chromatography) using a ultrahydrogel linear column by Waters Laboratory Analytics.

19. A plurality of fibers formed by the method of claim 3.

20. The fibers of claim 19, wherein the fibers have an average diameter of less than 1 μm.
